(19) United States
(12) Patent Application Publication
(10) Pub. No.: US 2017/0357798 A1
(43) Pub. Date: Dec. 14, 2017

(54) REMOVAL OF CREDENTIALS FROM AN ELECTRONIC DEVICE

(71) Applicant: Apple Inc., Cupertino, CA (US)

(72) Inventors: Ahmer A. Khan, Cupertino, CA (US); Matthias Lerch, Paris (FR); Vineet Chadha, Cupertino, CA (US)

(21) Appl. No.: 15/275,003

(22) Filed: Sep. 23, 2016

Related U.S. Application Data
(60) Provisional application No. 62/348,961, filed on Jun. 12, 2016.
(60) Provisional application No. 62/348,983, filed on Jun. 12, 2016.

(51) Int. Cl. G06F 21/45; G06Q 20/32; G06Q 20/40

(52) U.S. Cl. CPC G06F 21/45; G06Q 20/4014; G06Q 20/3278

(57) ABSTRACT

Systems, methods, and computer-readable media for managing credentials are provided. In one example embodiment, a method may include terminating the functionality of a security domain element on an electronic device, communicatively coupling the electronic device to a trusted service manager of the security domain element, and, after the terminating, communicating data from the electronic device to the communicatively coupled trusted service manager, wherein the communicated data is usable by the trusted service manager to determine a stored value of the security domain element. Additional embodiments are also provided.

### CROSS-REFERENCE TO RELATED APPLICATION(S)

This application claims the benefit of prior filed U.S. Provisional Patent Application No. 62/348,961, filed Jun. 12, 2016, and of prior filed U.S. Provisional Patent Application No. 62/348,983, filed Jun. 12, 2016, each of which is hereby incorporated by reference herein in its entirety.

### TECHNICAL FIELD

This disclosure relates to the management of credentials on an electronic device and, more particularly, to the removal of commerce credentials from an electronic device.

### BACKGROUND OF THE DISCLOSURE

Portable electronic devices (e.g., cellular telephones) may be provided with near field communication (“NFC”) components for enabling contactless proximity-based communications with another entity. Often times, these communications are associated with financial transactions or other secure data transactions that require the electronic device to access and share a commerce credential, such as a credit card credential or a public transportation ticket credential, previously provisioned on the device. However, the deletion of such commerce credentials from an electronic device is often inconvenient.

### SUMMARY OF THE DISCLOSURE

This document describes systems, methods, and computer-readable media for removing credentials from an electronic device.

For example, a method may be provided that includes terminating the functionality of a security domain element on an electronic device while the electronic device is not communicatively coupled to a trusted service manager of the security domain element, after the terminating, communicatively coupling the electronic device to the trusted service manager, and communicating data from the electronic device to the communicatively coupled trusted service manager, wherein the communicated data is usable by the trusted service manager to determine a stored value of the security domain element.

As another example, a method may include terminating the functionality of a security domain element on an electronic device, communicatively coupling the electronic device to a trusted service manager of the security domain element, and, after the terminating, communicating data from the electronic device to the communicatively coupled trusted service manager, wherein the communicated data is usable by the trusted service manager to determine a stored value of the security domain element.

This Summary is provided only to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters refer to like parts throughout, and in which:

FIG. 1 is a schematic view of an illustrative system for managing credentials on an electronic device;

FIG. 1A is a more detailed schematic view of the illustrative system of FIG. 1;

FIG. 2 is a more detailed schematic view of an example electronic device of the system of FIGS. 1 and 1A;

FIG. 2A is another more detailed schematic view of the electronic device of FIGS. 1-3;

FIG. 3 is a front view of the example electronic device of FIGS. 1-2A;

FIG. 4 is a more detailed schematic view of the example administration entity subsystem of the system of FIGS. 1 and 1A; and

FIGS. 5 and 6 are flowcharts of illustrative processes for managing credentials on an electronic device.

### DETAILED DESCRIPTION OF THE DISCLOSURE

The secure removal of a commerce credential from an electronic device may be initiated whether or not the electronic device is not communicatively coupled to a remote subsystem responsible for the management of that commerce credential. For example, whether or not the electronic device is communicatively coupled to the responsible remote subsystem, a life cycle state of the commerce credential may be updated locally on the electronic device such that the commerce credential may no longer be used by the electronic device in any commercial transaction with a merchant subsystem (e.g., in a contactless proximity-based credential transaction and/or in an online-based credential transaction) and/or such that the existence of the commerce credential on the electronic device may no longer be indicated by the device to a user of the device, and that updated life cycle state may be shared with the responsible remote subsystem when the electronic device is communicatively coupled to the responsible remote subsystem such that the responsible remote subsystem may take appropriate action to complete the secure deletion of the commerce credential from the electronic device, which may include retrieving a stored value of the credential from the electronic device, such that the retrieved value may be used without the electronic device in the future by an appropriate user. As another example, whether or not the electronic device is communicatively coupled to the responsible remote subsystem, the commerce credential may be marked for removal from the electronic device, and particular data may then be shared with the responsible remote subsystem when the electronic device is communicatively coupled to the responsible remote subsystem, where such data may be utilized by the responsible remote subsystem to identify, mark, and complete the removal.

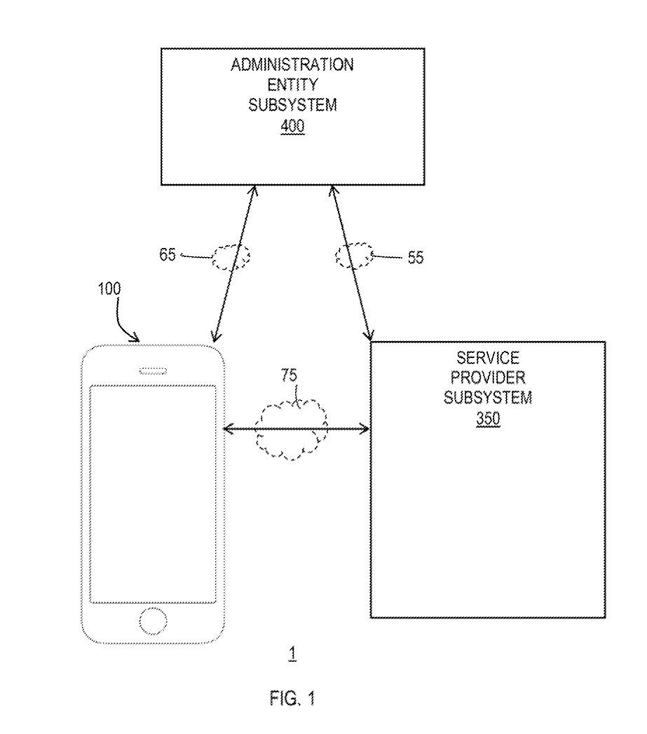

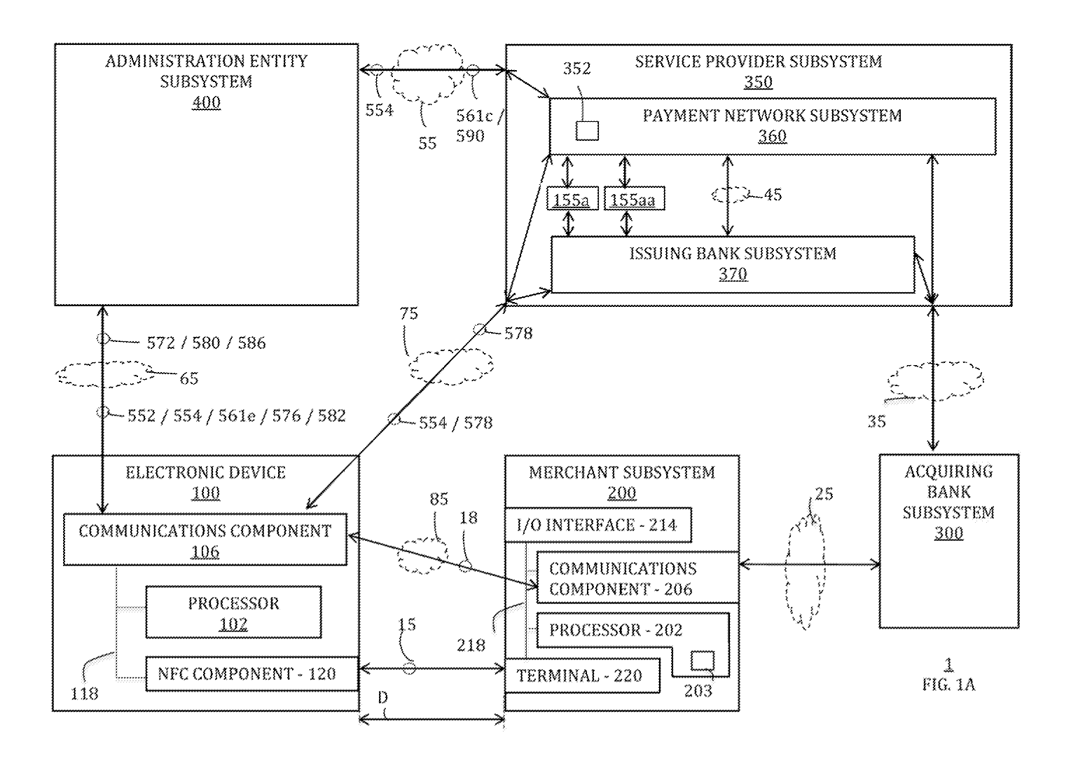

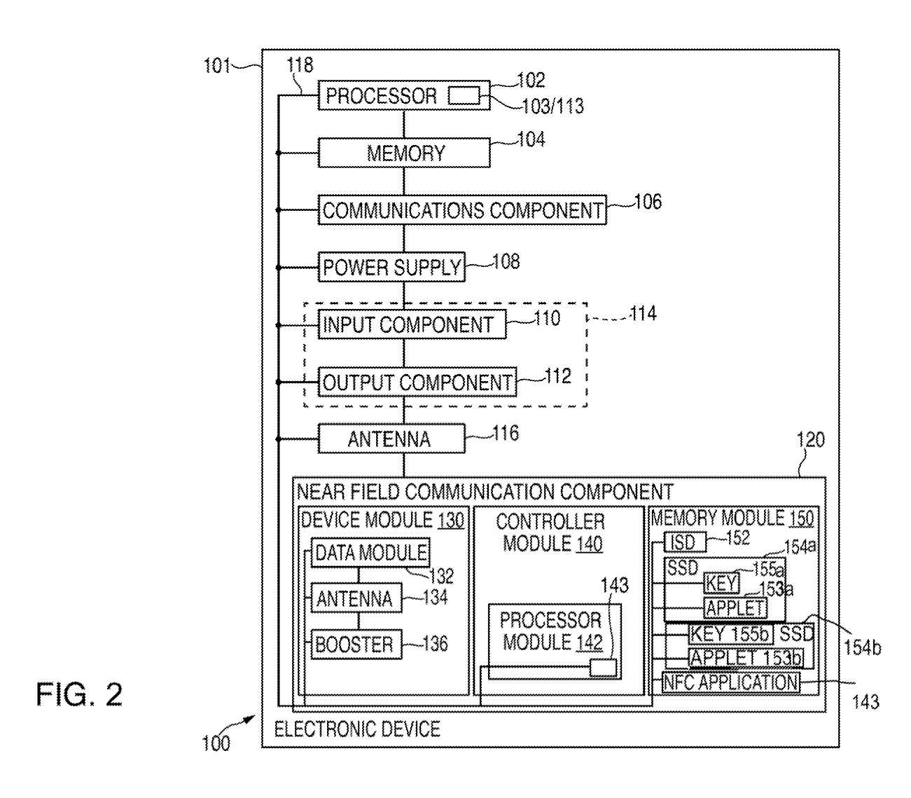

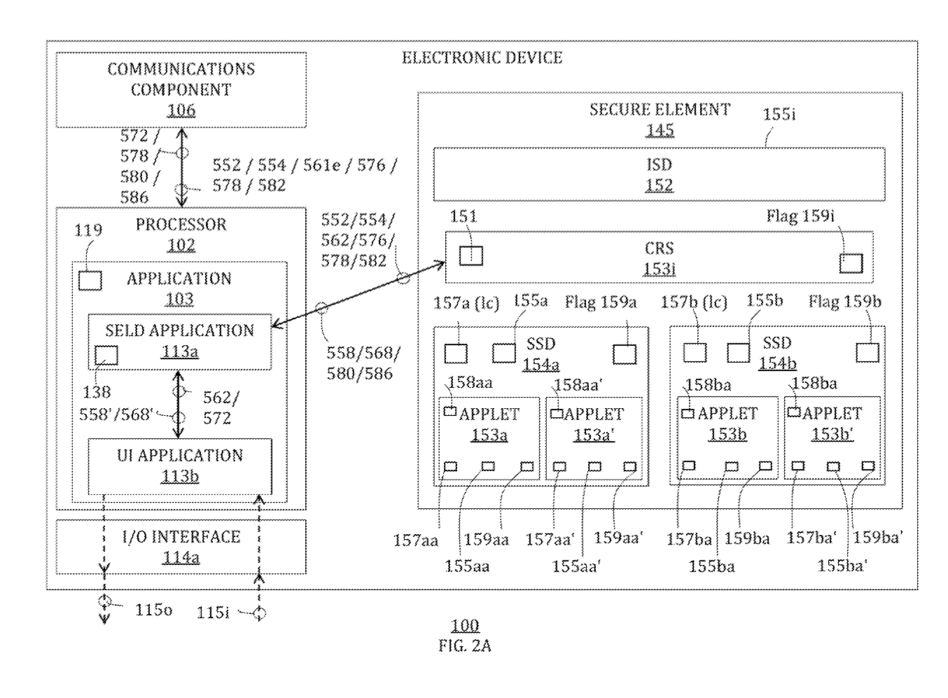

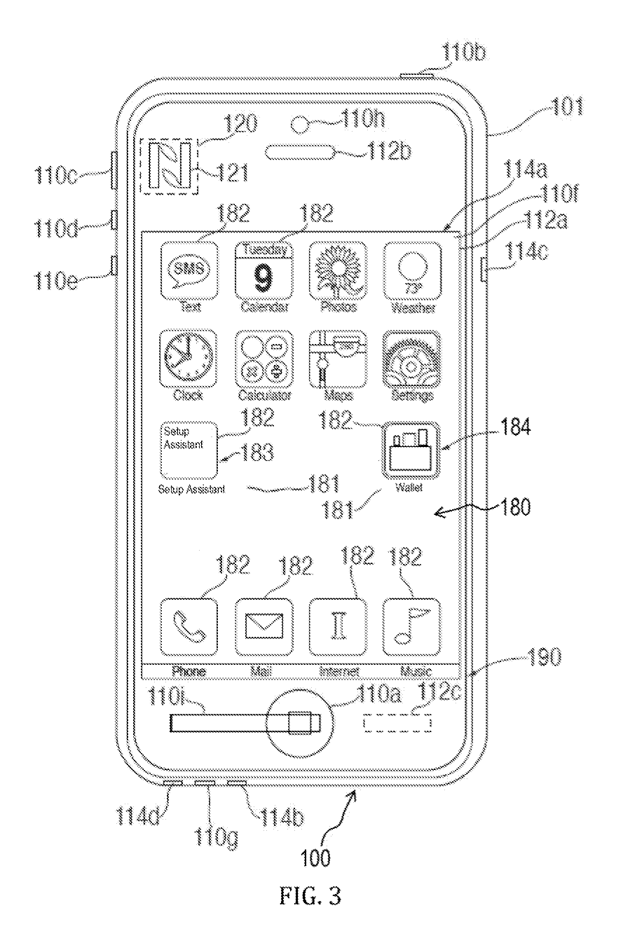

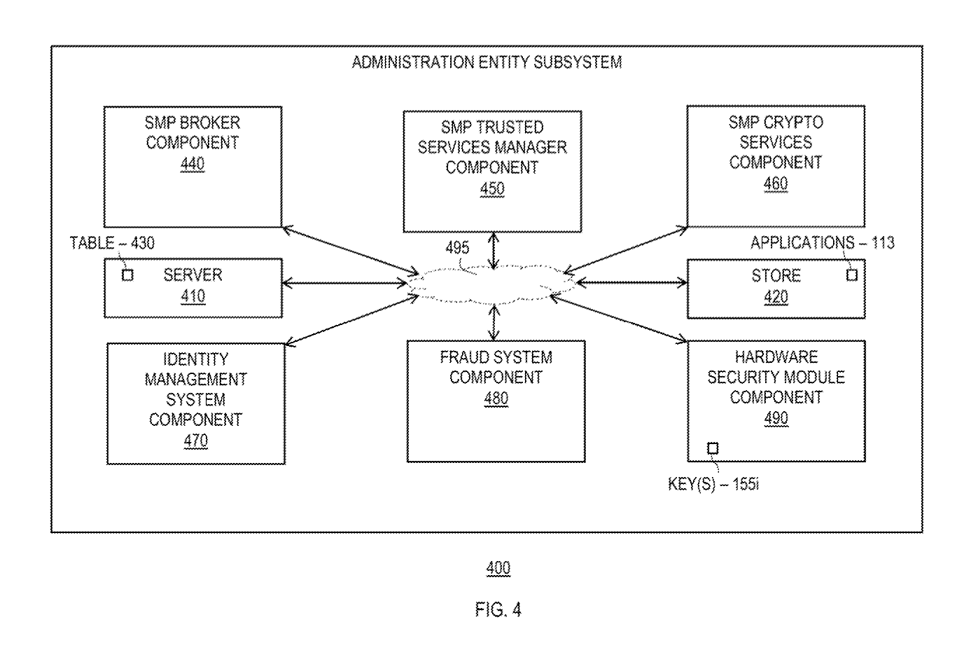

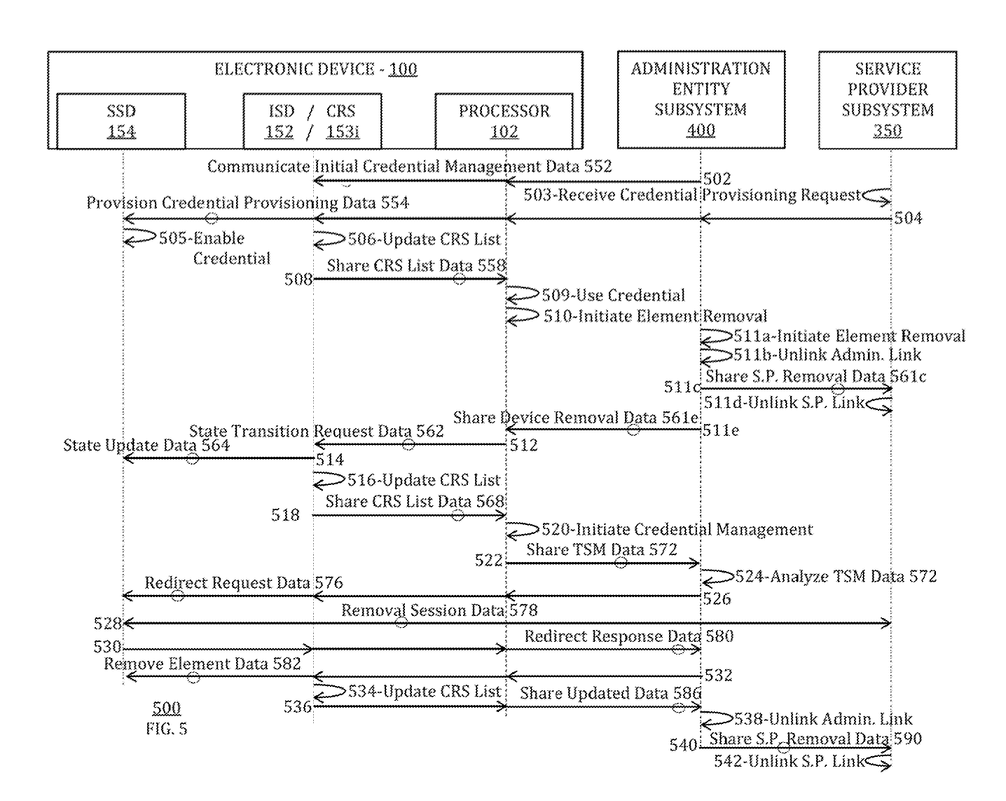

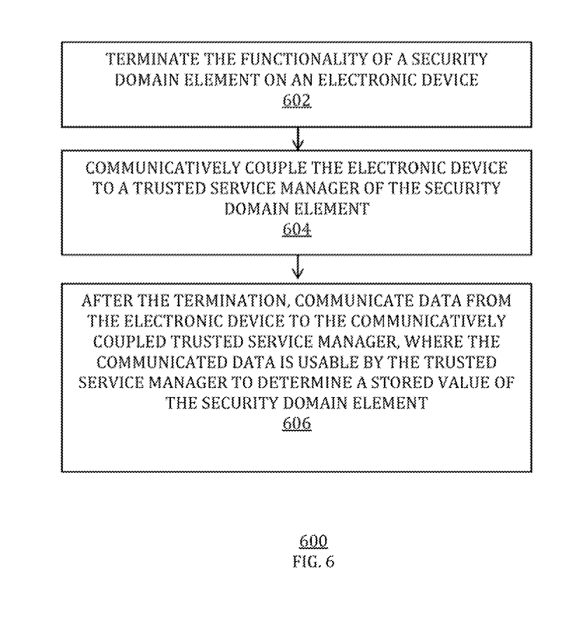

FIG. 1 shows a system 1 in which one or more credentials may be managed on an electronic device 100, such as credentials provisioned on and removed from electronic device 100 by a service provider subsystem 350 (e.g., in conjunction with an administration entity subsystem 400). FIG. 1A shows additional detail with respect to system 1 of FIG. 1, in which such credentials provisioned on electronic device 100 may be used by electronic device 100 for conducting a transaction with a program provider (or merchant) subsystem 200 and an associated acquiring bank subsystem 300. FIGS. 2-3 show further details with respect to particular embodiments of electronic device 100 of system 1, FIG. 4 shows further details with respect to particular embodiments of administration entity subsystem 400 of system 1, while FIGS. 5 and 6 are flowcharts of illustrative processes for managing credentials on electronic device 100 (e.g., in the context of system 1).

FIG. 1 is a schematic view of an illustrative system 1 that may allow for the management of credentials on an electronic device. For example, as shown in FIG. 1, system 1 may include an end-user electronic device 100 as well as an administration (or commercial) entity subsystem 400 and a service provider subsystem 350 (e.g., a service provider subsystem, transit subsystem, etc.) for securely provisioning credentials on electronic device 100 and/or for securely removing credentials from electronic device 100. Moreover, as shown in FIG. 1A, system 1 may also include a merchant subsystem 200 for receiving contactless proximity-based communications 15 (e.g., near field communications) from electronic device 100 based on such provisioned credentials, as well as an acquiring bank subsystem 300 that may utilize such contactless proximity-based communications 15 for completing a transaction with service provider subsystem 350.

System 1 may include a communications path 25 for enabling communication between merchant subsystem 200 and acquiring bank subsystem 300, a communications path 35 for enabling communication between acquiring bank subsystem 300 and service provider subsystem 350, a communications path 45 for enabling communication between a payment network subsystem 360 of service provider subsystem 350 and an issuing bank subsystem 370 of service provider subsystem 350 (e.g., when service provider subsystem 350 may be a financial institution subsystem), a communications path 55 for enabling communication between service provider subsystem 350 and administration entity subsystem 400, a communications path 65 for enabling communication between administration entity subsystem 400 and electronic device 100, a communications path 75 for enabling communication between service provider subsystem 350 and electronic device 100, and a communications path 85 for enabling online or suitable wireless communication between electronic device 100 and merchant subsystem 200. One or more of paths 25, 35, 45, 55, 65, 75, and 85 may be at least partially managed by one or more trusted service managers (“TSMs”). Any suitable circuitry, device, system, or combination of these (e.g., a wired and/or wireless communications infrastructure that may include one or more communications towers, telecommunications servers, or the like) that may be operative to create a communications network may be used to provide one or more of paths 25, 35, 45, 55, 65, 75, and 85, which may be capable of providing communications using any suitable wired or wireless communications protocol. For example, one or more of paths 25, 35, 45, 55, 65, 75, and 85 may support Wi-Fi (e.g., an 802.11 protocol), ZigBee (e.g., an 802.15.4 protocol), WiFi™, Ethernet, Bluetooth™, BLE, high frequency systems (e.g., 900 MHz, 2.4 GHz, and 5.6 GHz communication systems), infrared, TCP/IP, SCTP, DHCP, HTTP, BitTorrent™, FTP, RTP, RTSP, RTCP, RAOP, RDTP, UDP, SSH, WDS-bridging, any communications protocol that may be used by wireless and cellular telephones and personal e-mail devices (e.g., GSM, GSM plus EDGE, CDMA, OFDMA, HSPA, multi-band, etc.), any communications protocol that may be used by a low power Wireless Personal Area Network (“6LoWPAN”) module, any other communications protocol, or any combination thereof.

As shown in FIG. 2, and as described in more detail below, electronic device 100 may include a processor 102, memory 104, communications component 106, power supply 108, input component 110, output component 112, antenna 116, and near field communication (“NFC”) component 120, where input component 110 and output component 112 may sometimes be a single I/O component or I/O interface 114, such as a touch screen, that may receive input information through a user's touch of a display screen and that may also provide visual information to a user via that same display screen. Electronic device 100 may also include a bus 118 that may provide one or more wired or wireless communication links or paths for transferring data and/or power to, from, or between various other components of device 100. Electronic device 100 may also be provided with a housing 101 that may at least partially enclose one or more of the components of device 100 for protection from debris and other degrading forces external to device 100. Processor 102 may be used to run one or more applications, such as an application 103 and/or an application 113. Each one of applications 103 and 113 may include, but is not limited to, one or more operating system applications, firmware applications, media playback applications, media editing applications, communication applications, NFC applications, biometric feature-processing applications, or any other suitable applications. For example, processor 102 may load an application 103/113 as a user interface program to determine how instructions or data received via an input component 110 or other component of device 100 may manipulate the way in which information may be stored and/or provided to the user via an output component 112. As one example, application 103 may be an operating system application while application 113 may be a third party application (e.g., an application associated with a merchant of merchant subsystem 200 and/or an application associated with a service provider of service provider subsystem 350 and/or an application generated and/or maintained by administration entity subsystem 400). Application 103 and/or 113 may be accessed by processor 102 from any suitable source, such as from memory 104 (e.g., via bus 118) or from another device or server (e.g., via communications component 106). Processor 102 may include a single processor or multiple processors. For example, processor 102 may include at least one “general purpose” microprocessor, a combination of general and special purpose microprocessors, instruction set processors, graphics processors, video processors, and/or related chips sets, and/or special purpose microprocessors. Processor 102 also may include on board memory for caching purposes.

NFC component 120 may be any suitable proximity-based communication mechanism that may enable any suitable contactless proximity-based transactions or communications 15 between electronic device 100 and merchant subsystem 200 (e.g., a merchant payment terminal 220 of merchant subsystem 200). NFC component 120 may include any suitable modules for enabling contactless proximity-based communication 15 between electronic device 100 and subsystem 200. As shown in FIG. 2, for example, NFC component 120 may include an NFC device module 130, an NFC controller module 140, and an NFC memory module 150. NFC device module 130 may include an NFC data module 132, an NFC antenna 134, and an NFC booster 136. NFC controller module 140 may include at least one NFC processor module 142 that may be used to run one or more suitable applications, such as an NFC low power mode or wallet application 143, that may help dictate the function of NFC component 120 (e.g., dictate the communication of data between memory module 150 and device module 130 or antenna 116 (e.g., as a “wireless” or “contactless” communication interface) and/or between memory module 150 and processor 102 or memory 104 or communications component 106 (e.g., as a “wired” communication interface)). NFC memory module 150 may operate in conjunction with NFC device module 130 and/or NFC controller module 140 to allow for NFC communication 15 between electronic device 100 and merchant subsystem 200. NFC memory module 150 may be tamper resistant and may provide at least a portion of a secure element 145 of device 100 (see, e.g., FIG. 2A). For example, such a secure element 145 may be configured to provide a tamper-resistant platform (e.g., as a single or multiple chip secure microcontroller) that may be capable of securely hosting applications and their confidential and cryptographic data (e.g., applets 153 and keys 155) in accordance with rules and security requirements that may be set forth by a set of well-identified trusted authorities (e.g., an authority of service provider subsystem and/or an industry standard, such as GlobalPlatform).

As shown in FIGS. 2 and 4, NFC memory module 150 may include one or more of an issuer security domain (“ISD”) 152 and a supplemental security domain (“SSD”) 154 (e.g., a service provider security domain (“SPSD”), a trusted service manager security domain (“TSMSD”), etc.), which may be defined and managed by any suitable specification standard, such as an NFC specification standard (e.g., GlobalPlatform). For example, ISD 152 may be a portion of NFC memory module 150 in which a trusted service manager (“TSM”) or issuing institution (e.g., administration entity subsystem 400 and/or service provider subsystem 350 and/or merchant subsystem 200) may store keys and/or other suitable information for creating or otherwise provisioning one or more credentials (e.g., commerce credentials associated with various credit cards/accounts, bank cards/accounts, gift cards/accounts, access cards/accounts, loyalty cards/accounts, transit passes/accounts, etc.) on electronic device 100 (e.g., via communications component 106), for credential content management, and/or for security domain management. Certain commerce credentials may be personalized for a specific user and electronically linked to an account or accounts of a particular user with merchant subsystem 200 and/or administration entity subsystem 400 and/or service provider subsystem 350 (e.g., a personalized loyalty credential that may be registered to a particular user for accruing specific loyalty points and/or for receiving special offers (e.g., track frequent flier miles for a particular user's frequent flier account with a particular airline merchant subsystem)). Various types of commerce credentials or loyalty passes or loyalty cards or loyalty accounts may be associated with any suitable type of physical card and/or digital account, with or without an associated physical card, that may be maintained for a user, including, but not limited to, rewards cards/accounts, points cards/accounts, advantage cards/accounts, club cards/accounts, member cards/accounts, disloyalty cards/accounts, gift cards/accounts, stamp cards/accounts, class cards/accounts, private label account cards/accounts, reloadable account cards/accounts, non-reloadable prepaid account cards/accounts, punch cards/accounts, stored value cards/accounts (e.g., transit passes, eMoney card, etc.), credit cards/accounts, debit cards/accounts, charge cards/accounts, fleet cards/accounts, digital representations of the same, and the like. Commerce credential data indicative of such a card or account may be stored as at least a portion of a security domain element on device 100, such that when that security domain element is enabled that commerce credential data may be communicated from device 100 for use in carrying out a transaction with a remote entity (e.g., merchant subsystem 200 or service provider subsystem 350), where such commerce credential data (e.g., commerce credential information 158) may include any suitable data, including, but not limited to, a credit card payment number (e.g., a device primary account number (“DPAN”), DPAN expiry date, CVV, etc. (e.g., as a token or otherwise)) and/or cryptogram generation data and/or a monetary value of a stored value card and/or the like. A specific supplemental security domain (“SSD”) 154 (e.g., one of SSDs 154a and 154b) may be associated with a particular TSM and at least one specific commerce credential (e.g., a specific credit card credential or a specific stored value credential) that may provide specific privileges or payment rights to electronic device 100. Each SSD 154 may have its own manager key 155 (e.g., a respective one of keys 155a and 155b) and at least one of its own credential applications or credential applets (e.g., a Java card applet instance) associated with a particular commerce credential (e.g., credential applets 153a and 153a′ of SSD 154a and credential applets 153b and 153b′ of SSD 154b), where a credential applet may have its own applet key (e.g., applet key 155aa for credential applet 153a, applet key 155aa′ for credential applet 153a′, applet key 155ba for credential applet 153b, and applet key 155ba′ for credential applet 153b′) and credential information (e.g., credential information 158aa for credential applet 153a, credential information 158aa′ for credential applet 153a′, credential information 158ba for credential applet 153b, and credential information 158ba′ for credential applet 153b′), where a credential applet may need to be activated to enable its associated commerce credential (e.g., token and/or cryptogram credential data and/or at least a portion of a stored value (e.g., credential information 158 of that applet 153)) for use by NFC device module 130 as an NFC credential communication 15 between electronic device 100 and terminal 220 of merchant subsystem 200 (e.g., during an in-store financial transaction) and/or as an online credential communication 18 between communications component 106 of device 100 and communications component 206 of merchant subsystem 200 via any suitable communications path 85 of FIG. 1A (e.g., during an online financial transaction) using any suitable communications protocol over any suitable communications path type (e.g., via a TSM of communications path 85).

As also shown in FIG. 2A, for example, ISD 152 may include a key 155i that may also be known to a trusted service manager associated with that security domain (e.g., administration entity subsystem 400). Moreover, as also shown in FIG. 2A, ISD 152 may also include or be in any other way associated with a contactless registry services (“CRS”) applet or application 153i that may be configured to provide local functionality to electronic device 100 for modifying the life cycle state 157 (e.g., activated, deactivated, locked, etc.) of certain security domain elements and/or for sharing certain output information 115o about certain security domain elements in certain life cycle states with a user of device 100 (e.g., via a user I/O interface 114a). For example, as shown, CRS application 153i may include a CRS list 151 that may maintain a list of the current life cycle state of each security domain element on secure element 145 (e.g., life cycle state 157a of SSD 154a, life cycle state 157aa of credential applet 153a, life cycle state 157aa′ of credential applet 153a′, life cycle state 157b of SSD 154b, life cycle state 157ba of credential applet 153b, and life cycle state 157ba′ of credential applet 153b′), where CRS application 153i may be configured to share the life cycle state of one or more security domain elements of secure element 145 with an application of device 100 (e.g., with a secure element daemon (“SELD”) application 113a that may be running as a background process inside an operating system application 103 but that may not be under the control of an interactive user of device 100), which in turn may provide certain life cycle state information to a user of device 100 as output information 115o via I/O interface 114a and a user interface (“UI”) application (e.g., UI application 113b, such as a “wallet application”, as described below), which may enable a user to change a life cycle state of a security domain element (e.g., to update CRS list 151 and a life cycle state 157 of a security domain element, such as for enabling a commerce credential of a specific credential applet for use in an NFC communication 15 or online communication). As also shown in FIG. 2A, for example, device 100 may include any suitable device identification information or device identifier 119, which may be accessible to processor 102 or any other suitable portion of device 100. Device identification information 119 may be utilized by administration entity subsystem 400 and/or merchant subsystem 200 and/or service provider subsystem 350 for uniquely identifying device 100 to facilitate a transaction with merchant subsystem 200 and/or to enable any suitable secure communication with device 100. As just one example, device identification information 119 may be a telephone number or e-mail address or any unique identifier that may be associated with device 100.

As shown in FIG. 3, and as described below in more detail, a specific example of electronic device 100 may be a handheld electronic device, such as an iPhone™, where housing 101 may allow access to various input components 110a-110i, various output components 112a-112c, and various I/O components 114a-114d through which device 100 and a user and/or an ambient environment may interface with each other. For example, a touch screen I/O component 114a may include a display output component 112a and an associated touch input component 110f, where display output component 112a may be used to display a visual or graphic user interface (“GUI”) 180 (e.g., with output information 115o), which may allow a user to interact with electronic device 100. GUI 180 may include various layers, windows, screens, templates, elements, menus, and/or other components of a currently running application (e.g., application 103 and/or application 113 and/or application 143) that may be displayed in all or some of the areas of display output component 112a. For example, as shown in FIG. 3, GUI 180 may be configured to display a first screen 190 with one or more graphical elements or icons 182 of GUI 180. When a specific icon 182 is selected, device 100 may be configured to open a new application associated with that icon 182 and display a corresponding screen of GUI 180 associated with that application. For example, when the specific icon 182 labeled with a “Setup Assistant” textual indicator 181 (i.e., specific icon 183) is selected, device 100 may launch or otherwise access a specific setup application and may display screens of a specific user interface that may include one or more tools or features for interacting with device 100 in a specific manner according to that application (e.g., interaction that may enable a user to disable biometric authentication, erase all device contents, mark one, some, or all appropriate applets for removal (e.g., mark for delete or mark for freeze, etc.)). As another example, when the specific icon 182 labeled with a “Wallet” textual indicator 181 (i.e., specific icon 184) is selected, device 100 may launch or otherwise access a specific “passbook” or “wallet” application and may display screens of a specific user interface that may include one or more tools or features for interacting with device 100 in a specific manner according to that application (e.g., for presenting to a user all credentials available on device 100 for activation and use or any other suitable action (e.g., using pass information 138)).

Referring back to FIG. 1A, merchant subsystem 200 may include a reader or terminal 220 for detecting, reading, or otherwise receiving NFC communication 15 from electronic device 100 (e.g., when electronic device 100 comes within a certain proximity or distance D of terminal 220). Accordingly, it is noted that NFC communication 15 between merchant terminal 220 and electronic device 100 may occur wirelessly and, as such, may not require a clear “line of sight” between the respective devices. NFC device module 130 may be passive or active. When passive, NFC device module 130 may be activated when within a response range D of a suitable terminal 220 of merchant subsystem 200. For instance, terminal 220 of merchant subsystem 200 may emit a relatively low-power radio wave field that may be used to power an antenna utilized by NFC device module 130 (e.g., shared antenna 116 or NFC-specific antenna 134) and, thereby, enable that antenna to transmit suitable NFC communication information (e.g., credit card credential information) from NFC data module 132, via antenna 116 or antenna 134, to terminal 220 of merchant subsystem 200 as NFC communication 15. When active, NFC device module 130 may incorporate or otherwise have access to a power source local to electronic device 100 (e.g., power supply 108) that may enable shared antenna 116 or NFC-specific antenna 134 to actively transmit NFC communication information (e.g., credit card credential information) from NFC data module 132, via antenna 116 or antenna 134, to terminal 220 of merchant subsystem 200 as NFC communication 15, rather than reflect radio frequency signals, as in the case of a passive NFC device module 130. As also shown in FIG. 1A, and as described below in more detail, merchant subsystem 200 may also include a merchant processor component 202 that may be the same as or similar to a processor component 102 of electronic device 100, a merchant application 203 that may be the same as or similar to an application 103/113 of electronic device 100, a merchant communications component 206 that may be the same as or similar to a communications component 106 of electronic device 100, a merchant I/O interface 214 that may be the same as or similar to an I/O interface 114 of electronic device 100, a merchant bus 218 that may be the same as or similar to a bus 118 of electronic device 100, a merchant memory component (not shown) that may be the same as or similar to a memory component 104 of electronic device 100, and/or a merchant power supply component (not shown) that may be the same as or similar to a power supply component 108 of electronic device 100.

When NFC component 120 is appropriately enabled and activated to communicate NFC credential communication 15 and/or online credential communication data 18 to merchant subsystem 200 with commerce credential data associated with an enabled credential of device 100 (e.g., commerce credential data associated with enabled and activated applet 153a of SSD 154a of NFC component 120), merchant subsystem 200 may alone utilize such commerce credential data for processing a transaction (e.g., identifying merchant loyalty account information of the credential data if the activated applet is for a merchant loyalty credential on device 100) or acquiring bank subsystem 300 may utilize such commerce credential data of NFC communication data 15 and/or online communication data 18 for completing a commercial or financial transaction with service provider subsystem 350. Commerce credential data of an enabled security domain element may be any suitable data that may be useful in carrying out a transaction with a remote entity (e.g., merchant subsystem 200 or service provider subsystem 350), such as a credit card payment number (e.g., a device primary account number (“DPAN”), DPAN expiry date, CVV, etc. (e.g., as a token or otherwise)) and/or remaining monetary value of a stored value account and/or a stored value account number and/or the like. Service provider subsystem 350 may include a payment network subsystem 360 (e.g., a payment card association or a credit card association) and/or an issuing bank subsystem 370. For example, issuing bank subsystem 370 may be a financial institution that assumes primary liability for a consumer's capacity to pay off debts they incur with a specific financial payment credential. A specific financial payment credential of device 100 may or may not be associated with a specific payment card and may be electronically linked to an account or accounts of a particular user at a financial institution. A specific financial payment credential may be provisioned on electronic device 100 by issuing bank subsystem 370 for use in an NFC communication 15 with merchant subsystem 200. A specific financial payment credential may be a specific brand of payment card that may be branded by a payment network subsystem 360. Payment network subsystem 360 may be a network of various issuing banks 370 and/or various acquiring banks that may process the use of payment cards (e.g., commerce credentials) of a specific brand. Alternatively, or additionally, certain credentials that may be provisioned on device 100 for use in a commercial or financial transaction may be electronically linked to or otherwise associated with an account or accounts of a particular user, but not associated with any payment card. For example, a bank account or other financial account of a user may be associated with a credential provisioned on device 100 but may not be associated with any physical payment card.

Payment network subsystem 360 and issuing bank subsystem 370 may be a single entity or separate entities. For example, American Express may be both a payment network subsystem 360 and an issuing bank subsystem 370. In contrast, Visa and MasterCard may be payment network subsystems 360, and may work in cooperation with issuing bank subsystems 370, such as Chase, Wells Fargo, Bank of America, and the like. Service provider subsystem 350 may also include one or more acquiring banks, such as acquiring bank subsystem 300. For example, acquiring bank subsystem 300 may be the same entity as issuing bank subsystem 370. One, some, or all components of acquiring bank subsystem 300 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100. One, some, or all components of payment network subsystem 360 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100. One, some, or all components of issuing bank subsystem 370 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100.

To facilitate transactions within system 1, one or more credentials (e.g., commerce credentials) may be provisioned on electronic device 100. As shown in FIGS. 1 and 1A, administration entity subsystem 400 may be provided within system 1, where administration entity subsystem 400 may be configured to provide a new layer of security and/or to provide a more seamless user experience when it is being determined whether or not to provision a credential from service provider subsystem 350 on device 100 and/or whether or not to remove a credential from device 100. Administration entity subsystem 400 may be provided by a specific administration (or commercial) entity that may offer various services to a user of device 100. As just one example, administration entity subsystem 400 may be provided by Apple Inc. of Cupertino, Calif., which may also be a provider of various services to users of device 100 (e.g., the iTunes™ Store for selling/renting media to be played by device 100, the Apple App Store™ for selling/renting applications for use on device 100, the Apple iCloud™ Service for storing data from device 100, the Apple Online Store for buying various Apple products online, etc.), and which may also be a provider, manufacturer, and/or developer of device 100 itself (e.g., when device 100 is an iPod™, iPad™, iPhone™, Apple Watch™, MacBook™, or the like). Additionally or alternatively, administration entity subsystem 400 may be provided by a network operator (e.g., a mobile network operator, such as Verizon or AT&T, which may have a relationship with a user of device 100 (e.g., a data plan for enabling the communication of data over a certain communication path and/or using a certain communication protocol with device 100)).

The administration entity that may provide, manage, or at least partially control administration entity subsystem 400 may also provide different users with their own personalized accounts for using the services offered by that administration entity. Each user account with the administration entity may be associated with a specific personalized user ID and password that a user may use to log-in to their account with the administration entity. Each user account with the administration entity may also be associated with or have access to at least one commerce credential that can then be used by the user for purchasing services or products offered by the administration entity. For example, each Apple ID user account may be associated with at least one credit card of a user associated with that Apple ID, such that the credit card may then be used by the user of that Apple ID account for procuring services from Apple's iTunes™ Store, the Apple App Store™, the Apple iCloud™ Service, and the like. The administration entity that may provide, manage, or at least partially control administration entity subsystem 400 (e.g., Apple Inc.) may be distinct and independent from any service provider entity of service provider subsystem 350. For example, the administration entity that may provide, manage, or at least partially control administration entity subsystem 400 may be distinct and independent from any payment network subsystem 360 or issuing bank subsystem 370 that may furnish and manage any credit card or other commerce credential associated with a user account of the administration entity. Similarly, the administration entity that may provide, manage, or at least partially control administration entity subsystem 400 may be distinct and independent from any payment network subsystem 360 or issuing bank subsystem 370 that may furnish and manage any commerce credential to be provisioned on user device 100. Similarly, the administration entity that may provide, manage, or at least partially control administration entity subsystem 400 may be distinct and independent from any merchant subsystem 200. Such an administration entity may leverage the known commerce credential information associated with each of its user accounts and/or any suitable information that administration entity subsystem 400 may determine about device 100 in order to more securely determine with administration entity subsystem 400 whether a specific credential offered by service provider subsystem 350 ought to be provisioned on a user device 100 or removed therefrom. Additionally or alternatively, such an administration entity may leverage its ability to configure or control various components of device 100 (e.g., software and/or hardware components of device 100 when that administration entity at least partially produces or manages device 100) in order to provide a more seamless user experience for a user of device 100 when he or she wants to provision a credential offered by service provider subsystem 350 on device 100 or remove a credential therefrom.

As shown in FIG. 4, administration entity subsystem 400 may be a secure platform system and may include a secure mobile platform (“SMP”) broker component 440, an SMP trusted services manager (“TSM”) component 450, an SMP crypto services component 460, an identity management system (“IDMS”) component 470, a fraud system component 480, a hardware security module (“HSM”) component 490, store component 420, and/or one or more servers 410. One, some, or all components of administration entity subsystem 400 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100. One, some, or all components of administration entity subsystem 400 may be managed by, owned by, at least partially controlled by, and/or otherwise provided by a single administration entity (e.g., Apple Inc.) that may be distinct and independent from any service provider subsystem and/or from merchant subsystem 200. The components of administration entity subsystem 400 may interact with each other and collectively with any suitable service provider subsystem and/or electronic device 100 and/or merchant subsystem 200 for providing a new layer of security and/or for providing a more seamless user experience.

SMP broker component 440 of administration entity subsystem 400 may be configured to manage user authentication with an administration entity user account and/or to manage service provider and/or merchant validation. SMP broker component 440 may also be configured to manage the lifecycle and provisioning of credentials on device 100. SMP broker component 440 may be a primary end point that may control the user interface elements (e.g., elements of GUI 180) on device 100. An operating system or other application of an end user device (e.g., application 103, application 113, and/or application 143 of device 100) may be configured to call specific application programming interfaces (“APIs”) and SMP broker 440 may be configured to process requests of those APIs and respond with data that may derive the user interface of device 100 and/or respond with application protocol data units (“APDUs”) that may communicate with device 100 (e.g., via a communication path 65 between administration entity subsystem 400 and electronic device 100). Such APDUs may be received by administration entity subsystem 400 from a service provider subsystem via a trusted services manager (“TSM”) of system 1 (e.g., a TSM of a communication path between administration entity subsystem 400 and a remote subsystem (e.g., service provider subsystem 350)). SMP TSM component 450 of administration entity subsystem 400 may be configured to provide GlobalPlatform-based services or any other suitable services that may be used to carry out credential provisioning operations on device 100 from service provider subsystem 350. GlobalPlatform, or any other suitable secure channel protocol, may enable SMP TSM component 450 to properly communicate and/or provision sensitive account data between secure element 145 of device 100 and a TSM for secure data communication between administration entity subsystem 400 and service provider subsystem 350.

SMP TSM component 450 may be configured to use HSM component 490 to protect keys and generate new keys. SMP crypto services component 460 of administration entity subsystem 400 may be configured to provide key management and cryptography operations that may be provided for user authentication and/or confidential data transmission between various components of system 1. SMP crypto services component 460 may utilize HSM component 490 for secure key storage and/or opaque cryptographic operations. A payment crypto service of SMP crypto services component 460 may be configured to interact with IDMS component 470 to retrieve information associated with on-file credit cards or other types of commerce credentials associated with user accounts of the administration entity (e.g., an Apple iCloud™ account). Such a payment crypto service may be configured to be the only component of administration entity subsystem 400 that may have clear text (e.g., non-hashed) information describing commerce credentials (e.g., credit card numbers) of its user accounts in memory. IDMS component 470 may be configured to enable and/or manage any suitable communication between device 100 and another device, such as an identity services (“IDS”) transport (e.g., using an administration entity-specific service (e.g., iMessage™ by Apple Inc.)). For example, certain devices may be automatically or manually registered for such a service (e.g., all devices in an eco-system of administration entity 400 may be automatically registered for the service). Such a service may provide an end-to-end encrypted mechanism that may require active registration before messages can be sent using the service. IDMS component 470 and/or any other suitable server or portion of administration entity subsystem 400 may be operative to identify or otherwise lookup the status of any credentials provisioned on any electronic devices associated with a given user account or otherwise, such that administration entity subsystem 400 may be operative to efficiently and effectively identify one or more non-native credentials that may be available to a particular client device associated with a particular user account (e.g., multiple devices of a family account with administration entity subsystem 400). Administration entity fraud system component 480 of administration entity subsystem 400 may be configured to run an administration entity fraud check on a commerce credential based on data known to the administration entity about the commerce credential and/or the user (e.g., based on data (e.g., commerce credential information) associated with a user account with the administration entity and/or any other suitable data that may be under the control of the administration entity and/or any other suitable data that may not be under the control of a remote subsystem). Administration entity fraud system component 480 may be configured to determine an administration entity fraud score for the credential based on various factors or thresholds. Additionally or alternatively, administration entity subsystem 400 may include store 420, which may be a provider of various services to users of device 100 (e.g., the iTunes™ Store for selling/renting media to be played by device 100, the Apple App Store™ for selling/renting applications for use on device 100 (e.g., application 113), the Apple iCloud™ Service for storing data from device 100 and/or associating multiple user devices and/or multiple user profiles with one another, the Apple Online Store for buying various Apple products online, etc.). As just one example, store 420 may be configured to manage and provide an application 113 to device 100 (e.g., via communications path 65), where application 113 may be any suitable application, such as a banking application, a program provider application, an e-mail application, a text messaging application, an internet application, a card management application, or any other suitable communication application. Any suitable communication protocol or combination of communication protocols may be used by administration entity subsystem 400 to communicate data amongst the various components of administration entity subsystem 400 (e.g., via at least one communications path 495 of FIG. 4) and/or to communicate data between administration entity subsystem 400 and other components of system 1 (e.g., service provider subsystem 350 via communications path 55 of FIG. 1 and/or electronic device 100 via communications path 65 of FIG. 1). The components of administration entity subsystem 400 may interact with each other and collectively with both service provider subsystem 350 and electronic device 100 for providing a new layer of security and/or for providing a more seamless user experience when managing credentials on device 100.

FIG. 5 is a flowchart of an illustrative process 500 for managing commerce credentials on an electronic device (e.g., for provisioning a credential on an electronic device and/or for removing a credential from an electronic device). Process 500 is shown being implemented by various elements of system 1 of FIGS. 1-4 (e.g., electronic device 100, service provider subsystem 350, and administration entity subsystem 400). However, it is to be understood that process 500 may be implemented using any other suitable components or subsystems. For example, as an alternative to service provider subsystem 350, a merchant subsystem 200 may be used by process 500 in a similar fashion to provision a credential on an electronic device and/or to remove a credential from an electronic device. Process 500 may provide a seamless user experience for securely removing or otherwise permanently disabling a credential previously provisioned on device 100 (e.g., with or without requiring network connectivity between device 100 and a TSM (e.g., service provider subsystem 350 and/or administration entity subsystem 400)) and/or while still enabling recovery of credential value from device 100. This may enable a user to remove a credential's functionality from device 100 permanently without first establishing a network connection between device 100 and a remote subsystem. This may be beneficial when a first user of device 100 would like to remove certain credentials from device 100 before selling or otherwise transferring control of device 100 to a second user or when device 100 has become misplaced despite no network connectivity between device 100 and a trusted service manager of the credentials (e.g., service provider subsystem 350 and/or administration entity subsystem 400) while also enabling recovery of credential value from device 100. Alternatively, process 500 may provide a seamless user experience for securely removing or otherwise permanently disabling a credential previously provisioned on device 100 while there may be network connectivity between device 100 and a TSM (e.g., service provider subsystem 350 and/or administration entity subsystem 400) while also enabling recovery of credential value from device 100.

Process 500 may begin at step 502, where initial credential management data 552 may be provided on an electronic device. For example, ISD 152, which may include or otherwise be associated with ISD key 155i and CRS application 153i, may be provided on secure element 145 of NFC component 120 of electronic device 100 (e.g., by administration entity subsystem 400) as at least a portion of initial credential management data 552, where such initial credential management data 552 may be utilized by NFC component 120 for initially configuring secure element 145 to manage the provisioning and/or deletion of one or more commerce credentials on secure element 145 by a remote subsystem. ISD key 155i may also remain accessible to administration entity subsystem 400 (e.g., a copy of ISD key 155i may be stored on or otherwise used by administration entity subsystem 400), which may be used as a shared secret of secure element 145 and administration entity subsystem 400 to enable secure communication of data therebetween. In such embodiments, administration entity subsystem 400 may be considered a secure element issuer trusted service manager (“SEI-TSM”), and such initial credential management data 552 may be provided by administration entity subsystem 400 to electronic device 100 via communications path 65 of FIG. 1. For example, communications component 106 of electronic device 100 may be configured to communicate such initial credential management data 552 with administration entity subsystem 400 using any suitable communications protocol over any suitable communications path 65. Additionally or alternatively, SELD application 113a, UI application 113b, operating system application 103, and/or any other suitable applications may be made accessible to device 100 by administration entity subsystem 400 (e.g., from a store component of administration entity subsystem 400 (e.g., Apple's App Store™)) as at least a portion of initial credential management data 552, where such initial credential management data 552 may be utilized by device 100 for enabling a user of device 100 to actively manage the life cycle states of various elements on secure element 145 (e.g., via I/O interface 114a).

Next, at step 503, process 500 may include system 1 receiving a request to provision a credential on electronic device 100. For example, step 503 may include service provider subsystem 350 receiving any suitable request for a particular credential (e.g., commerce or payment credential) to be provisioned on device 100 (e.g., a request initiated by a user of device 100 via interaction with an application of device 100 (e.g., through user interaction with GUI 180 on I/O interface 114a of device 100, such as during use of a setup assistant application associated with “Setup Assistant” icon 183 of FIG. 3 and/or during use of a “Passbook” or “Wallet” application associated with “Wallet” icon 184 of FIG. 3 and/or during use of a third party application (e.g., an application associated with a merchant of merchant subsystem 200 and/or an application associated with a service provider of service provider subsystem 350)), a request initiated by administration entity subsystem 400, and/or a request generated by service provider subsystem 350 itself). Such a request of credential provisioning may include any suitable identification information associated with the selected credential that may be used by service provider subsystem 350 for provisioning that credential onto device 100 (e.g., the card verification value (“CVV”) for the selected credential, the expiration date for the selected credential, the billing address for the selected credential, etc.). Moreover, such a request may include any other suitable information that may be useful for enabling the provisioning of the selected credential on device 100 (e.g., information associated with the target device 100, such as an SSD identifier, which may be indicative of an available SSD 154 of NFC component 120 of device 100 that may be able to receive such a provisioned credential, and/or a device identifier, which may be unique to device 100 with respect to one or more remote subsystems of system 1 (e.g., device identification information 119)).

Next, at step 504, process 500 may include provisioning the credential identified at step 503 on electronic device 100. For example, credential provisioning data 554 may be communicated to electronic device 100 by service provider subsystem 350 (e.g., directly or via administration entity subsystem 400) at step 504 for provisioning at least a first credential applet 153a of a first SSD 154a on secure element 145 of electronic device 100. In such embodiments, service provider subsystem 350 may be considered a service provider trusted service manager (“SP-TSM”). In response to receiving a request at step 503, various routines may occur at step 504 for provisioning a requested credential on electronic device 100. For example, step 504 may include service provider subsystem 350 (e.g., payment network subsystem 360) generating a descriptor of the selected credential to be provisioned, as well as visual artwork and/or other metadata that may be provided on device 100 for aiding user interaction with the credential once provisioned (e.g., for defining a pass to be used for presentation to and interaction with a user of device 100). Particularly, at step 504 of process 500 of FIG. 5, service provider subsystem 350 may pull specific data from the credential provisioning request (e.g., the credential identification information for the credential requested at step 503), access one or more databases of information available to service provider subsystem 350 that may be useful for generating one or more descriptors and/or various types of metadata that may aid any eventual user interaction with the credential once provisioned on device 100, and then generate and transmit at least a portion of credential provisioning data 554 to device 100 (e.g., at least partially via administration entity subsystem 400). For example, such credential provisioning data 554 may include some or all suitable pass information 138 that may enable device 100 to make the credential visually appear as available to device 100, such as visual logos/icons and other user discernible data associated with the credential that may be provided to the user (e.g., when the specific icon 182 labeled with a “Wallet” textual indicator 181 (i.e., specific icon 184) of FIG. 3 is selected, device 100 may launch or otherwise access a specific passbook or wallet application and may display screens of a specific user interface that may include one or more visual descriptors of the credential (e.g., as a pass) if the credential is in a life cycle state that is to be accessible to a user of device 100), and any suitable credential information 158 associated with pass information 138 that may enable device 100 to generate and share credential data operative to securely enable transfer of value from a user of device 100 to a merchant subsystem or to any other remote subsystem. Such credential provisioning data 554 generated by service provider subsystem 350 may be transmitted by service provider subsystem 350 (e.g., by an appropriate payment network subsystem 360) to administration entity subsystem 400 (e.g., to SMP broker component 440 of administration entity subsystem 400) via communications path 55 of FIG. 1 using any suitable communications protocol over any suitable communications path type (e.g., via a TSM of communications path 55) and then such credential provisioning data 554 may be passed on by administration entity subsystem 400 to device 100 via communications path 65 of FIG. 1 using any suitable communications protocol over any suitable communications path type (e.g., via a TSM of communications path 65). Alternatively, such credential provisioning data 554 generated by service provider subsystem 350 may be transmitted by service provider subsystem 350 to device 100 via communications path 75 of FIG. 1 using any suitable communications protocol over any suitable communications path type (e.g., via a TSM of communications path 75) and then confirmed by device 100 to administration entity subsystem 400. Therefore, administration entity subsystem 400 may be provided with information to enable administration entity subsystem 400 to maintain a table 430 with data indicative of credentials provisioned on device 100, including data indicative of which service provider subsystem provisioned such credentials and the state of each credential and/or the type of each credential (e.g., stored value or otherwise) and/or the like.

System 1 and/or process 500 may be configured to provision a virtual credential on device 100 rather than the actual credential that may be initially requested for provisioning at step 503. For example, once it is determined that a credential is to be provisioned on device 100, it may be requested (e.g., by service provider subsystem 350, by administration entity subsystem 400 at step 503, and/or by a user of device 100 at step 503) that a virtual credential be generated, linked to the actual credential, and provisioned on device 100 instead of the actual credential identified at step 503. That is, administration entity subsystem 400 may generate and transmit credential provisioning instruction data to service provider subsystem 350 at step 503 that may also include a specific instruction for service provider subsystem 350 to create a new virtual credential (e.g., a device primary account number (“D-PAN”)), link that virtual credential with the selected actual credential (i.e., a funding primary account number (“F-PAN”) originally issued by the issuing bank), and then provision that virtual credential onto device 100. Accordingly, in such embodiments, service provider subsystem 350 may generate and transmit commerce credential provisioning data 554 at step 504 that may include a descriptor of the virtual credential (e.g., the D-PAN) to be provisioned and any suitable metadata that ought to be provided on device 100 for aiding user interaction with the virtual credential to be provisioned. Such linking or other suitable association of a virtual credential with an actual credential may be performed by any suitable component of service provider subsystem 350. For example, service provider subsystem 350 (e.g., a particular payment network subsystem 360 that may be associated with the brand of the actual credential identified at step 503) may define and store an entry in a virtual-linking table or data structure 352 (e.g., as shown in FIG. 1A) at step 504 of process 500, where such an entry may create an association or link between the actual credential and a virtual credential. Thus, when a virtual credential is utilized by device 100 for a financial transaction with merchant subsystem 200 (e.g., after the virtual credential has been provisioned on device 100), service provider subsystem 350 may receive an authorization request indicative of that virtual credential (e.g., as data from acquiring bank subsystem 300 or from merchant subsystem 200) and may conduct an analysis of that authorization request in light of the actual credential associated or otherwise linked with the identified virtual credential as determined by virtual-linking table 352. Additionally or alternatively, table 352 may include data associating a credential (e.g., a virtual credential and/or an actual credential (e.g., by applet identifier, PAN, and/or the like)) with a particular electronic device 100 or at least a particular secure element 145 of a device 100 on which that credential is provisioned and/or with a particular user of device 100 (e.g., using a device identifier (e.g., device identifier 119) or an Apple ID of an Apple ID user account of administration entity subsystem 400 or any other suitable user ID of any suitable user account, such as an account with service provider subsystem 350). Thus, when a list of credentials provisioned on a device 100 may be provided to service provider subsystem 350 (e.g., as described below with respect to step 540), service provider subsystem 350 may confer with data entries of table 352 to determine if one or more credentials previously provisioned on device 100 by service provider subsystem 350 has been functionally removed (e.g., marked-for-delete or marked-for-freeze) (e.g., as described below with respect to step 542). Service provider subsystem 350 may use such data of table 352 to track when a credential previously provisioned on a first device of a particular user or user group has been rendered permanently unusable and a stored value of that credential, such that unusable stored value of the first device may be appropriately provisioned on other device of that user or user group.

By provisioning a virtual credential on device 100 rather than an actual credential, service provider subsystem 350 may be configured to limit the fraudulent activity that may result if the virtual credential is intercepted by an unauthorized user (e.g., by an NFC communication 15 signal stealer positioned adjacent device 100 and/or merchant terminal 220), as service provider subsystem 350 (e.g., payment network subsystem 360) may only be configured to utilize virtual-linking table 352 for linking the virtual credential to the actual credential during certain transactions (e.g., during NFC transactions received by merchant terminal 220 and not during online transactions or other transactions that may allow credential information to be manually entered by a user). Therefore, in such embodiments using a virtual credential, commerce credential provisioning data 554 generated by service provider subsystem 350 may contain a new D-PAN (e.g., new virtual credential information) from an entry in table 352 that may define a link between an F-PAN (e.g., an actual credential banking number) of the selected credential identified at step 503 and this new D-PAN. Credential provisioning data 554 may also include the last four digits or any other suitable data of the linked F-PAN for creating a hashed version of the F-PAN. Providing both the virtual D-PAN and a hashed version of the actual F-PAN on device 100 may prevent user confusion between the two and may enable easier user association of the two when utilizing a virtual credential for a financial transaction. Therefore, in some embodiments, a full version of an F-PAN (e.g., an actual credential banking number) may never be stored on device 100, but rather only an associated D-PAN (e.g., a linked virtual credential) may be stored in non-hashed form on device 100. Commerce credential provisioning data 554 may also include a unique D-PAN hash (e.g., the last four digits of the D-PAN and/or any other suitable data for creating a hashed version of the D-PAN that may be used in all subsequent calls to reference this D-PAN while maintaining security of the D-PAN). Credential provisioning data 554 may also include an “AuthToken” or any other suitable token that may be a one-time use token for enabling provision of the credential. Credential provisioning data 554 may also include put pending command data that may include the primary account number (e.g., D-PAN or F-PAN, hashed or not) of the credential being provisioned, an SSD identifier, and/or an SSD counter.

As mentioned, administration entity subsystem 400 (e.g., SMP broker component 440 and/or SMP-TSM component 450 of administration entity subsystem 400) may pass credential provisioning data 554 onto device 100 as part of step 504, where such credential provisioning data 554 may include any suitable description or identification of the credential to be provisioned (e.g., a hashed-version of the credential's PAN, virtual and/or actual (e.g., D-PAN and/or F-PAN)), as well as any associated metadata. Such credential provisioning data 554 may also include one or more personalization scripts (e.g., persoScripts) or GlobalPlatform application protocol data unit (“APDU”) scripts (e.g., any scripts, any rotate keys (e.g., if necessary), and any other suitable administrative elements that may be used to provision a usable PAN on device 100). Such credential provisioning data 554 may also include information associated with the particular SSD 154 of device 100 that may have the credential provisioned thereon (e.g., an SSD identifier of a particular SSD 154, as may be provided by step 503). Such credential provisioning data 554 may be transmitted by administration entity subsystem 400 to electronic device 100 via communications path 65 of FIG. 1. For example, communications component 106 of electronic device 100 may be configured to receive credential provisioning data 554 using any suitable communications protocol over any suitable communications path 65. In some embodiments, credential provisioning data 554 may be transmitted by administration entity subsystem 400 to device 100 as encrypted with ISD key 155i as may be accessible to both administration entity subsystem 400 and ISD 152 of device 100. Alternatively or additionally, at least some of credential provisioning data 554 may be provided to electronic device 100 directly from service provider subsystem 350 at step 504 (e.g., via communications path 75 of FIG. 1, where communications component 106 of electronic device 100 may be configured to receive commerce credential provisioning data 554 using any suitable communications protocol over any suitable communications path 75). Credential provisioning data 554 may be generated and transmitted by service provider subsystem 350 as encrypted with an SSD key 155a of the target SSD 154a and/or with a credential applet key 155aa of the new commerce credential applet 153a being provisioned at step 504, where SSD key 155a and/or credential applet key 155aa may be accessible to service provider subsystem 350 (e.g., as shown in FIG. 1). By encrypting at least some of commerce credential provisioning data 554 using an SSD key 155a and/or a credential applet key 155aa that may be known to service provider subsystem 350 (e.g., as a shared secret with secure element 145), at least some of the information of credential provisioning data 554 may be inaccessible to a subsystem that may not have access to such a key (e.g., administration entity subsystem 400 may not have such a key even if that credential provisioning data 554 may be passed through administration entity subsystem 400 from service provider subsystem 350 to device 100 at step 504).

After step 504, once credential provisioning data 554 has been received by electronic device 100, device 100 may be configured to complete any of the received scripts from credential provisioning data 554 of step 504 and/or take any other suitable action for enabling the credential (e.g., for toggling the credential from a disabled state to an enabled state) at step 505 of process 500, such that the actual credential identified at step 503 may have an associated credential applet 153 (e.g., commerce credential applet 153a of SSD 154a) enabled on secure element 145 for eventual use in an NFC communication 15 for a transaction (e.g., when activated). SSD 154a may also be provisioned on secure element 145 along with credential applet 153a based on credential provisioning data 554 of step 504. Alternatively, SSD 154a may have been previously created on secure element 145, such that only credential applet 153a and not SSD 154a may be provisioned on secure element 145 based on credential provisioning data 554 of step 504. Once a new credential applet 153a has been provisioned on SSD 154a of secure element 145 of device 100 at step 504, SSD 154a may include SSD key 155a and SSD life cycle state 157a, while credential applet 153a may include applet key 155aa and applet life cycle state 157aa. At step 506 of process 500, CRS list 151 of CRS application 153i may be updated (e.g., by ISD 152) to reflect the new life cycle states of secure element 145 (e.g., at least the new life cycle state 157aa of new credential applet 153a and/or its new credential information 158aa as just provisioned on device 100 at step 504/505). For example, in some embodiments, the initial life cycle state 157aa of a credential applet 153a provisioned on a secure element may be configured to be enabled but “DEACTIVATED” at step 505 and reflected as such in CRS list 151 at step 506, whereby a user of device 100 may later activate the credential applet 153a for use in an NFC communication 15 (e.g., update life cycle state 157aa of credential applet 153a to “ACTIVATED”). After CRS list 151 has been updated at step 506 to reflect the life cycle state of the newly provisioned credential applet 153a, process 500 may proceed to step 508, where at least certain data from CRS list 151 of secure element 145 may be shared with processor 102 of device 100 (e.g., with SELD application 113a) as shared CRS list data 558, and where at least certain information of shared CRS list data 558 may be selectively shared by SELD application 113a with UI application 113b as shared user CRS list data 558′, which may then be selectively provided by UI application 113b as output information 115o to a user of device 100 (e.g., via I/O interface 114a or any other suitable output component of device 100, as shown in FIG. 2A). Device 100 may then be used at step 509 (e.g., by a user interacting with UI application 113b (e.g., with pass information 138) through the use of user input information 115i) to change the life cycle state of a credential provisioned on secure element 145 (e.g., life cycle state 157aa of credential applet 153a) to “ACTIVATED” for use in one or more ways (e.g., for use of the credential data (e.g., credential information 158) of an activated secure domain element in an NFC communication 15 and/or online communication 18 with merchant subsystem 200 to conduct a financial or other suitable commerce transaction). For example, the visual artwork and/or other metadata of credential provisioning data 554 that may be provided on device 100 at step 504 (e.g., pass information 138) for aiding user interaction with a provisioned credential may be used at step 509 for identifying the credential to a user as output information 115o, and credential data (e.g., based on credential information 158) that may be communicated from device 100 to merchant subsystem 200 for funding a transaction may include any suitable data that may be operative to securely prove proper ownership of the particular secure element credential of device 100 (e.g., the credential of applet 153a of SSD 154a), including, but not limited to, (i) token data (e.g., a DPAN, DPAN expiry date, and/or CVV of credential information 158a of applet 153a) and (ii) crypto data (e.g., a cryptogram that may be generated by secure element 145 using a shared secret of SSD 154a and service provider subsystem 350 (e.g., key 155a and/or key 155aa) and any other suitable information (e.g., some or all of the token data, information identifying device 100, information identifying some or all potential transaction data for the transaction to be funded, such as cost and/or currency, any suitable counter values, nonce, etc.) that may be available to device 100, and which may also be made available to service provider subsystem 350 (e.g., for independently generating the crypto data using the shared secret)).

As mentioned, process 500 may be configured to allow an electronic device to mark a commerce credential or other security domain element for removal, such as for deletion or for freeze, with or without requiring authentication and/or secure channel setup and/or network connectivity with a trusted service manager (e.g., with SEI-TSM administration entity subsystem 400 and/or with SP-TSM service provider subsystem 350). Device 100 may be configured to transition one or more certain security domain elements of NFC component 120 (e.g., SSDs 154a and 154b and/or credential applets 153a, 153a′, 153b, and 153b′) to a new life cycle state “ELEMENT_TERMINATED,” which may make that element unusable via any wireless interface and via any wired interface, or to a new life cycle state “ELEMENT_FROZEN,” which may make that element unusable via any wireless interface but may allow at least certain credential information of that element to be communicated via a wired interface (e.g., to allow a stored value of that element to be shared by device 100 with a remote subsystem (e.g., with an appropriate remote server (e.g., with an appropriate service provider subsystem 350 that provisioned or is otherwise at least partially responsible for that element))).

The ELEMENT_TERMINATED life cycle state of a security domain element may be similar to a “LOCKED” state that may be covered by GlobalPlatform, however the transition to the ELEMENT_TERMINATED state may be irreversible and may act as a permanent local disable or mark-for-delete functionality for that security domain element. A transition of a security domain element to such an ELEMENT_TERMINATED life cycle state may thereafter make the credential data (e.g., token and/or cryptogram generation (e.g., credential information 158)) of that security domain element unusable for carrying out a transaction with a remote entity via any wireless interface (e.g., as data between memory module 150 and device module 130 or antenna 116 (e.g., as a “wireless” or “contactless” communication interface), such as for a contactless proximity-based or NFC credential communication 15 with merchant terminal 220) and/or via any wired interface (e.g., as data between memory module 150 and processor 102 or memory 104 or communications component 106 (e.g., as a “wired” communication interface), such as for an online credential communication 18 with merchant communications component 206). Then, at any time after the life cycle state for a particular security domain element has been transitioned to ELEMENT_TERMINATED, an owner or trusted service manager of the security domain of that transitioned element (e.g., administration entity subsystem 400), who may have content management privileges for that security domain, may later delete the transitioned element according to any suitable protocol (e.g., according to GlobalPlatform, for example, by setting up a secure channel path between device 100 and the TSM, and then issuing a DELETE command) or may in any other suitable way reconcile the permanent disablement of the credential. Therefore, a security domain element (e.g., a provisioned credential) may be permanently disabled on device 100 without requiring network connectivity between device 100 and a TSM (e.g., service provider subsystem 350 and/or administration entity subsystem 400 that may share a key with the security domain element) at the time of permanent disablement. This may enable a user to remove a credential's functionality from device 100 permanently without first establishing a network connection between device 100 and a remote subsystem. This may be beneficial when a first user would like to remove certain credentials from device 100 before selling device 100 to a second user despite no network connectivity between device 100 and a trusted service manager. Therefore, once the life cycle state of a security domain element (e.g., a provisioned credential) on device 100 has been transitioned to ELEMENT_TERMINATED, the credential data of that security domain element may not be used by device 100 as a part of any contactless proximity-based communication 15 (e.g., near field communication) with merchant terminal 220 and/or as a part of any other suitable communication 18 with merchant subsystem 200 or otherwise for pursuing any commercial transaction.

The ELEMENT_FROZEN life cycle state of a security domain element may be similar to a “LOCKED” state that may be covered by GlobalPlatform, however the transition to the ELEMENT_FROZEN state may be irreversible and may act as a permanent local disable or mark-for-freeze functionality for that security domain element that may still enable certain credential data (e.g., a stored value) of that security domain element to be accessible by a remote subsystem. A transition of a security domain element to such an ELEMENT_FROZEN life cycle state may thereafter make the credential data of that security domain element unusable for carrying out a transaction with a remote entity via any wireless interface (e.g., as data between memory module 150 and device module 130 or antenna 116 (e.g., as a “wireless” or “contactless” communication interface), such as for a contactless proximity-based or NFC credential communication 15 with merchant terminal 220) and unusable for carrying out certain data transactions with a remote entity via any wired interface (e.g., a Shareable Interface Object (“SIO”) of a marked-for-freeze security domain element may be made not functional by a transition to the ELEMENT_FROZEN state to prevent certain credential data of that security domain element from being communicated as data between memory module 150 and processor 102 or memory 104 or communications component 106 (e.g., as a “wired” communication interface), such as for a communication of online data to a remote subsystem for funding a particular transaction (e.g., as online payment data 18 to communications component 206 of merchant subsystem 200 via communications path 85)), but may thereafter still enable the communication of certain credential data (e.g., a stored value) of that security domain element with one or more certain appropriate remote entities via any wired interface to retrieve and salvage a stored value of that security domain element for later use (e.g., as data between memory module 150 and processor 102 or memory 104 or communications component 106 (e.g., as a “wired” communication interface), such as for a communication of stored value data with administration entity subsystem 400 via path 65 and/or with service provider subsystem 350 via path 75 and/or paths 65 and 55). For example, the SIO may be made non-functional by configuring an applet, when marked-for-freeze or marked-for-delete, to not return a shared object (e.g., can be configured to decide in a call getAppletShareableInterfaceObject (caller, parameter) to not return the shared object). When not frozen or deleted, an applet may be configured to check the caller identity to allow only a specific caller to retrieve the shareable object. Yet, when frozen or deleted, the applet may be configured to return the object, but limit its functionality. For example, the SIO may be used only for online payment and implement only one method. Alternatively, a frozen applet may be configured to block the use of the object according to a first method but block the use of the object according to a second method (e.g., share with an SP). Then, at any time after the life cycle state for a particular security domain element has been transitioned to ELEMENT_FROZEN and after certain commerce credential data from that transitioned security domain element (e.g., the remaining monetary value and/or associated account information of a stored value of a transitioned security domain element) has been accessed by an authorized remote subsystem (e.g., service provider subsystem 350), the owner or trusted service manager (e.g., administration entity subsystem 400) of the security domain of that transitioned element, which may have content management privileges for that security domain (e.g., a remote server that may have access to a shared secret (e.g., authorization keys) of the security domain (e.g., a subsystem responsible for previously provisioning the credential on to the security domain)), may later delete the transitioned element according to any suitable protocol (e.g., according to GlobalPlatform, for example, by setting up a secure channel path between device 100 and the TSM, and then issuing a redirect request command to device 100 for enabling sharing of the remaining monetary stored value with an appropriate service provider subsystem and then issuing a DELETE command for permanently disabling the credential) or may in any other suitable way reconcile the permanent disablement of the credential after retrieving a stored value of a marked-for-freeze security domain element.

Before a life cycle state of a security domain element of device 100 may be transitioned to such an ELEMENT_TERMINATED state or to such an ELEMENT_FROZEN state, that security domain element must first be configured to even allow such a transition. That is, one or some or all security domain elements of device 100 may each be configured to include a data field or any other suitable feature that can be set either to allow the security domain element to be transitioned to an ELEMENT_TERMINATED state or to prevent the security domain element from being transitioned to an ELEMENT_TERMINATED state. Additionally, or alternatively, one or some or all security domain elements of device 100 may each be configured to include a data field or any other suitable feature that can be set either to allow the security domain element to be transitioned to an ELEMENT_FROZEN state or to prevent the security domain element from being transitioned to an ELEMENT_FROZEN state. Alternatively, one or some or all security domain elements of device 100 may each be configured to include a data field or any other suitable feature that can be set (1) to allow the security domain element to be transitioned to an ELEMENT_TERMINATED state or (2) to allow the security domain element to be transitioned to an ELEMENT_FROZEN state or (3) to prevent the security domain element from being transitioned to either the ELEMENT_FROZEN state or the ELEMENT_TERMINATED state. In some embodiments, two different bits or two different registers or two different bits of a single register may be used for identifying if an applet supports mark-for-delete versus mark-for-freeze (e.g., at the time of creating an applet, administration entity subsystem 400 (e.g., SMP TSM component 450) or SP subsystem 350 may set such bits appropriately (e.g., based on the type of applet being created and/or provisioned)). For example, two of one register may be set at installation time of an applet to allow either mark-for-delete (e.g., byte 1, bit 2 of an extended functionality indicator of the applet) or mark-for-freeze (e.g., byte 1, bit 8 of an extended functionality indicator of the applet). Both together may not be possible. The nature of the applet (e.g., credit card credential or eMoney stored value credential), for example, may be known at installation time although it may be determined later when the issuer data may be personalized into the applet. For example, some or all security domain elements of secure element 145 of device 100 may be configured to include at least one flag or bit register or any other suitable defined data field or functionality data register 159 that may be set for either allowing or preventing such transition(s). For example, as shown in FIG. 2A, security domain element ISD 152 or CRS application 153i may include at least one functionality data register 159i, security domain element SSD 154a may include at least one functionality data register 159a, security domain element credential applet 153a may include at least one functionality data register 159aa, security domain element credential applet 153a′ may include at least one functionality data register 159aa′, security domain element SSD 154b may include at least one functionality data register 159b, security domain element credential applet 153b may include at least one functionality data register 159ba, and/or security domain element credential applet 153b′ may include at least one functionality data register 159ba′, where each functionality data register 159 of each security domain element may be independently set to either allow or prevent a transition of the life cycle state 157 of that security domain element to the ELEMENT_TERMINATED state and/or to the ELEMENT_FROZEN state.

Whether the functionality data register 159 of a particular security domain element is set to allow or prevent such a life cycle state transition may be determined by the manager of that security domain element and may not be changed by a user of device 100. In some embodiments, the functionality data register 159 of a security domain element may be set when that security domain element is installed or otherwise provisioned on device 100. For example, functionality data register 159i of CRS application 153i of ISD 152 may be set by administration entity subsystem 400 at step 502 of process 500 when initial credential management data 552 is provided to device 100. Additionally, or alternatively, as another example, functionality data register 159aa of credential applet 153a may be set by service provider subsystem 350 or administration entity subsystem 400 at step 504 of process 500 when commerce credential provisioning data 554 is provided to device 100. In some embodiments, functionality data register 159i of CRS application 153i may be set (e.g., to a value “00”) so as to prevent CRS application 153i from being transitioned to an ELEMENT_TERMINATED state or to an ELEMENT_FROZEN state, while functionality data register 159aa of credential applet 153a may be set (e.g., to a value “01”) so as to allow life cycle state 157aa of credential applet 153a to be transitioned to an ELEMENT_TERMINATED state but not to an ELEMENT_FROZEN state, while functionality data register 159aa′ of credential applet 153a′ may be set (e.g., to a value “10”) so as to allow life cycle state 157aa′ of credential applet 153a′ to be transitioned to an ELEMENT_FROZEN state but not to an ELEMENT_TERMINATED state. Other components of secure element 145 may also be configured to be prevented from being transitioned to an ELEMENT_TERMINATED state and/or to an ELEMENT_FROZEN state, such as a controlling authority security domain (“CASD”) (not shown). Moreover, in some particular embodiments, a life cycle state of a particular SSD may be prevented from transitioning to an ELEMENT_TERMINATED state and/or to an ELEMENT_FROZEN state while a life cycle state of a particular credential applet of that SSD may be allowed to transition to an ELEMENT_TERMINATED state and/or to an ELEMENT_FROZEN state. For example, functionality data register 159a of SSD 154a may be set (e.g., to a value “00”) so as to prevent SSD 154a from being transitioned to an ELEMENT_TERMINATED state or to an ELEMENT_FROZEN state, yet functionality data register 159aa of credential applet 153a of SSD 154a may be set (e.g., to a value “01”) so as to allow life cycle state 157aa of credential applet 153a to be transitioned to an ELEMENT_TERMINATED state, while functionality data register 159aa′ of credential applet 153a′ of SSD 154a may be set (e.g., to a value “10”) so as to allow life cycle state 157aa′ of credential applet 153a′ to be transitioned to an ELEMENT_FROZEN state. In some embodiments, a trusted service manager at install of a security domain element may enable the security domain element to be transitioned to an ELEMENT_FROZEN state but not an ELEMENT_TERMINATED state if that security domain element (e.g., credential applet) may be configured to include a stored value (e.g., a value that may be decremented off of device 100 during use (e.g., the value may be decremented off of device 100 when value is extracted to fund a transaction with merchant subsystem 200 (e.g., when the credential is a stored value card))). Alternatively, a trusted service manager at install of a security domain element may enable the security domain element to be transitioned to an ELEMENT_TERMINATED state but not an ELEMENT_FROZEN state if that security domain element (e.g., credential applet) may be configured to be linked to a funding account of a service provider subsystem (e.g., a funding account at an issuing bank subsystem 370) rather than include a stored value.

As one particular example, a functionality data register 159 of a security domain element of device 100 may be set in the “Extended Functionality Indicator,” as may be stored in “Application Discretionary Data” of the contactless parameters in the “User Interaction Parameters”, where GlobalPlatform may define such Application Discretionary Data to be used by a CRS application (see, e.g., GlobalPlatform Technical Specification 2.2.1, v1.1, which is hereby incorporated by reference herein in its entirety). Such Application Discretionary Data may be wrapped inside constructed basic encoding rules (“BER”) tag 0xA6 (see, e.g., GlobalPlatform Technical Specification 2.2.1, v1.1, Amendment C, Table 3-13, which is hereby incorporated by reference herein in its entirety). As a specific example, bit 2 of byte 1 (least significant bit (“LSB”)) of the Extended Functionality Indicator of a specific security domain element may be set either to “0” (e.g., not set) for preventing the transition of the life cycle state of that security domain element to ELEMENT_TERMINATED or to “1” (e.g., set) for allowing the transition of the life cycle state of that security domain element to ELEMENT_TERMINATED. When the functionality data register of a security domain element is set by a trusted service manager at install of the security domain element, the content management privileges of such a trusted service manager (e.g., service provider subsystem 350 and/or administration entity subsystem 400) may require or otherwise utilize authentication and a secure channel for ensuring the authenticity and integrity of the functionality data register value. CRS application 153i and/or any other application of secure element 145 (e.g., NFC application 143) may leverage the functionality data register of security domain elements while processing life cycle state update requests. For example, CRS list 151 may not only include state information for the life cycle state of some or all security domain elements of device 100, but CRS list 151 may also include state information for the functionality data register(s) of some or all of those security domain elements as well, such that shared CRS list data 558 or any other data indicative of CRS list 151 may indicate not only the life cycle state of a security domain element but also whether or not that security domain element is able to be transitioned to the ELEMENT_TERMINATED state and/or to the ELEMENT_FROZEN state.

As mentioned, process 500 may be configured to allow an electronic device to mark a credential or other security domain element for removal, such as for deletion or for freezing with or without requiring authentication and/or secure channel setup and/or network connectivity with a trusted service manager (e.g., with SEI-TSM administration entity subsystem 400 and/or with SP-TSM service provider subsystem 350). At some point during the life of a security domain element on device 100, device 100 (e.g., CRS application 153i) may be instructed (e.g., by processor 102) to transition the life cycle state of the security domain element to a removal state, such as to an ELEMENT_TERMINATED state or to an ELEMENT_FROZEN state. For example, at step 510 of process 500, a user of device 100 may interact with UI application 113b (e.g., with input information 115i via I/O interface 114a) to instruct device 100 to transition the life cycle state of a particular security domain element to a removal state, such as to an ELEMENT_TERMINATED state or to an ELEMENT_FROZEN state (e.g., step 510 may provide a user with an opportunity to selectively remove a credential from device 100 but not provide the user with the distinguishing delete removal or freeze removal options, as the credential may be pre-defined for one of those particular removal types that may not be altered by the user). As mentioned, this may be desirable by a user when he or she wishes to sell or otherwise transfer device 100 to a new person who should not have access to one or more commerce credentials on device 100, especially when device 100 is not communicatively connected to a trusted service manager of that commerce credential at the time of the transfer. Alternatively or additionally, such a user instruction may not specifically identify a specific security domain element but instead the user instruction may be a more generic “clear all personal information” command that may have implications across multiple applications and not just for SELD application 113a and CRS application 153i. Alternatively or additionally, such an instruction may be generated automatically by an application of device 100 in response to a particular condition (e.g., in response to a specific number of failed user log-in attempts (e.g., ten unsuccessful entries of a user passcode to gain functional access to device 100)) and/or not in response to a particular user interaction. Alternatively, as described with respect to step 511a, in an alternative embodiment, such an initiate element removal instruction may not be generated on device 100 but may be generated on another device or subsystem of system 1. For example, a user may interact with a remote entity or secondary device (e.g., a user's secondary device (e.g., similar to device 100 but distinct from device 100, such as a user's laptop computer as a secondary device to device 100 as a mobile telephone device)) to provide an instruction to initiate removal of one or more credentials on device 100 (e.g., via accessing an online portal to a user's account at administration entity subsystem 400 for managing user devices (e.g., an iCloud account of a user may be accessed by a secondary device and an instruction (e.g., a remote wipe instruction) may be received by administration entity subsystem 400 at step 511a that may be eventually used to remove one or more credentials from device 100 when communication is enabled between device 100 and administration entity subsystem 400)).

Continuing with the example of step 510, a user instruction may be provided by UI application 113b to SELD application 113a as a state transition request, which may then be communicated to ISD 152 or CRS application 153i at step 512 of process 500 as state transition request data 562. Next, at step 514 of process 500, ISD 152 or CRS application 153i may process state transition request data 562 and potentially update the life cycle state of a particular security domain element to ELEMENT_TERMINATED or to ELEMENT_FROZEN by transmitting suitable life cycle state update data 564 to each particular security domain element identified by state transition request data 562. For example, CRS application 153i may process state transition request data 562 to determine whether a particular security domain element indicated by state transition request data 562 is able to be transitioned to the ELEMENT_TERMINATED state or to the ELEMENT_FROZEN state (e.g., by identifying the state information for the functionality data register of that particular security domain element) and, if so, then transmit suitable life cycle state update data 564 to that particular security domain element for updating the life cycle state of that security domain element to ELEMENT_TERMINATED or to ELEMENT_FROZEN as appropriate. No access control (e.g., secure channel between device 100 and the TSM of the security domain element to be transitioned) may be required to issue the command of life cycle update data 564 of step 514. That is, the communicative coupling between device 100 and administration entity subsystem 400 and/or service provider subsystem 350 that may be required at step 504 for the provisioning of the security domain element on device 100 may be terminated or otherwise non-existent during step 510, 512, and/or step 514. The state of a security domain element may be transitioned to the ELEMENT_TERMINATED state or to the ELEMENT_FROZEN state locally on device 100 without requiring any communication between device 100 and a trusted service manager. UI application 113b may leverage previously shared CRS list data 558 (e.g., from step 508) to determine which security domain elements of device 100 are able to be transitioned to the ELEMENT_TERMINATED state or to the ELEMENT_FROZEN state (e.g., based on state information for the functionality data register of some or all of the security domain elements) and may only enable a user to select from those particular security domain elements for instructing device 100 to transition the state of a security domain element to a removal state (e.g., a generic removal state or one of a specific ELEMENT_TERMINATED or ELEMENT_FROZEN state) at step 510. Alternatively, UI application 113b may enable a user to select from all security domain elements for instructing device 100 to transition the state of a security domain element to a removal state at step 510, and only ISD 152 and/or CRS application 153i at step 514 may determine whether or not to allow state transition request data 562 to trigger a state transition to ELEMENT_TERMINATED or ELEMENT_FROZEN through analysis of the state information for the functionality data register of the identified security domain element.

State transition request data 562 may be configured to identify any suitable security domain element for transitioning to the ELEMENT_TERMINATED state or ELEMENT_FROZEN state. For example, state transition request data 562 may request that life cycle state 157aa of credential applet 153a be transitioned to the ELEMENT_TERMINATED state or to the ELEMENT_FROZEN state. If the state of functionality data register 159aa of credential applet 153a indicates the allowance of such a state change, ISD 152 may update life cycle state 157aa of credential applet 153a to the ELEMENT_TERMINATED state or to the ELEMENT_FROZEN state at step 514. As another example, state transition request data 562 may request that life cycle state 157a of SSD 154a be transitioned to the ELEMENT_TERMINATED state or to the ELEMENT_FROZEN state. If the state of functionality data register 159a of SSD 154a indicates the allowance of such a state change, ISD 152 may update life cycle state 157a of SSD 154a to the ELEMENT_TERMINATED state or to the ELEMENT_FROZEN state at step 514. Consequentially, such a transition may be configured to transition the life cycle state of each security domain element within SSD 154a to the ELEMENT_TERMINATED state or to the ELEMENT_FROZEN state as well (e.g., both life cycle state 157aa of credential applet 153a and life cycle state 157aa′ of credential applet 153a′ of SSD 154a may also be updated to ELEMENT_TERMINATED or ELEMENT_FROZEN state in response to such state transition request data 562 for SSD 154a). Therefore, the life cycle state of either a specific credential applet or an entire SSD may be transitioned to ELEMENT_TERMINATED or ELEMENT_FROZEN at step 514. In other embodiments, only particular applets of or associated with an SSD may be transitioned to a removed state while the SSD itself may remain on the secure element and not be transitioned to a removed state.

In particular embodiments, process 500 may be configured to utilize a proprietary or otherwise new life cycle state ELEMENT_TERMINATED or ELEMENT_FROZEN through using a unique coding structure that may be accessible to applicable standards (e.g., to GlobalPlatform Technical Specification 2.2.1, v1.1). For example, life cycle state coding may be coded bitwise and, in order to avoid conflict with any existing valid life cycle states, the new ELEMENT_TERMINATED life cycle state may use a coding of “10000001” for bits 8-1 and the new ELEMENT_FROZEN life cycle state may use a coding of “10000010” for bits 8-1, where other existing valid life cycle states may include coding of “00000011” for an “INSTALLED” state, “00000111” for a “SELECTABLE” state, “0XXXX111” for application-specific states, and “1XXXXX11” for a “LOCKED” state. In some embodiments, device 100 may be configured to treat a security domain element in the ELEMENT_TERMINATED state or ELEMENT_FROZEN state as if it were in the LOCKED state except that any attempt to transition the state from ELEMENT_TERMINATED or ELEMENT_FROZEN to a different state shall fail. Device 100 may be configured to transition the life cycle state of a security domain element to the ELEMENT_TERMINATED state or the ELEMENT_FROZEN state through an application using GlobalPlatform Technical Specification 2.2.1's application programming interface (“API”) “GPRegistryEntry method setState( )”. For example, an application requesting this state transition (e.g., CRS application 153i) may be configured to have the “Global Registry and Contactless Activation” privilege. A limitation of such a “GPRegistryEntry method setState( )” may be extended to include this new ELEMENT_TERMINATED state and/or this new ELEMENT_FROZEN state, where a transition request to a state other than LOCKED, UNLOCKED, ELEMENT_TERMINATED, and ELEMENT_FROZEN may only be accepted if the invoking application corresponds to this GPRegistryEntry. Device 100 may be configured to make possible a transition to the ELEMENT_TERMINATED state or the ELEMENT_FROZEN state from most or all original life cycle states, including from the LOCKED state to the ELEMENT_TERMINATED state or to the ELEMENT_FROZEN state. In response to receiving a “SET STATUS” command (e.g., from SELD application 113a), CRS application 113i may not be configured to support transitioning a security domain element to the ELEMENT_TERMINATED state or the ELEMENT_FROZEN state. Device 100 may be configured to apply one or more certain limitations to a requested transition of a particular security domain element's life cycle state to ELEMENT_TERMINATED or ELEMENT_FROZEN. For example, if any application currently running on device 100 (e.g., at the initiation of step 514) is referencing the security domain element (e.g., through an internal interface), then device 100 may be configured to prevent that security domain element from transitioning to the ELEMENT_TERMINATED state or the ELEMENT_FROZEN state. It is also to be understood that, in some embodiments, it may be possible to transition globally all applications (e.g., applets) with a single command that may transition each application to the ELEMENT_TERMINATED state or the ELEMENT_FROZEN state if that application is capable of doing so (e.g., is in a PERSONALIZED life cycle). Global transitioning of applets into mark-for-freeze or mark-for-delete may be subject to different rules, such as, if the transition of one applet fails, then no other applet shall be transitioned to mark-for-freeze or mark-for-delete, or, if the transition of one applet fails, then all other applets should be transitioned, regardless of the failure.

Next, at step 516 of process 500, CRS list 151 of CRS application 153i may be updated (e.g., by ISD 152) to reflect the new life cycle states of secure element 145 (e.g., at least the new ELEMENT_TERMINATED life cycle state or the new ELEMENT_FROZEN life cycle state of the at least one particular security domain element identified by data 562 and 564). After CRS list 151 has been updated at step 516 to reflect the life cycle state of the newly removed security domain element, process 500 may proceed to step 518, where at least certain data from CRS list 151 of secure element 145 may be shared with processor 102 of device 100 (e.g., with SELD application 113a) as shared CRS list data 568, and where at least certain information of shared CRS list data 568 may be selectively shared by SELD application 113a with UI application 113b as shared user CRS list data 568′, which may then be selectively provided by UI application 113b as output information 115o to a user of device 100 (e.g., via I/O interface 114a or any other suitable output component of device 100, as shown in FIG. 2A). Device 100 may then be used at step 520 (e.g., by a user interacting with UI application 113b through the use of user input information 115i) to manage credentials of device 100 in one or more ways. For example, a user may interact with UI application 113b and output information 115o to provide new input information 115i for selecting a credential application for use in a financial transaction at step 520.

As mentioned, device 100 may be configured to treat a security domain element in the ELEMENT_TERMINATED state or ELEMENT_FROZEN state as if it is in the LOCKED state except that any attempt to transition the state from ELEMENT_TERMINATED or ELEMENT_FROZEN to a different state shall fail. However, in some embodiments, device 100 may be configured to prevent any indication of a security domain element that is in the ELEMENT_TERMINATED state or ELEMENT_FROZEN state to a user of device 100. For example, if life cycle state 157aa of credential applet 153a is transitioned to the ELEMENT_TERMINATED state or ELEMENT_FROZEN state at step 564 and shared CRS list data 568 indicates this status to processor 102 at step 518, UI application 113b may be configured to never present any information indicative of credential applet 153a to a user of device 100 from that point forward (e.g., as output information 115o at step 520). That is, although output information 115o may have been indicative of credential applet 153a (e.g., using pass information 138) at step 509 where a user may have selected and activated that credential applet 153a for use in a transaction and/or at step 510 where a user may have selected that credential applet 153a for transitioning to the ELEMENT_TERMINATED state or ELEMENT_FROZEN state, once its state has been transitioned to ELEMENT_TERMINATED or ELEMENT_FROZEN, all information indicative of the existence of credential applet 153a on device 100 (e.g., associated pass information 138) may be permanently prevented from being shared with a user of device 100 (e.g., as output information 115o by UI application 113b via I/O interface 114a at step 520). Such indicative information (e.g., associated pass information 138) may include all visual artwork and/or other metadata described above for a provisioned credential at step 504. In some embodiments, SELD application 113a may be configured to detect which security domain elements are in the ELEMENT_TERMINATED state or ELEMENT_FROZEN state (e.g., through analysis of shared CRS list data 568) and may only pass on shared user CRS list data 568′ information to UI application 113b (see, e.g., FIG. 2A) that is indicative of security domain elements that are not in the ELEMENT_TERMINATED state or ELEMENT_FROZEN state. That is, SELD application 113a may be configured to prevent UI application 113b from receiving any information from secure element 145 related to any security domain element that is in the ELEMENT_TERMINATED state or ELEMENT_FROZEN state. In other embodiments, UI application 113b may be configured to receive CRS list data 568′ that is the same as CRS list data 568 received by SELD application 113a, and UI application 113b may be configured to prevent the presentation of information to a user that is indicative of a security domain element that is in the ELEMENT_TERMINATED state or ELEMENT_FROZEN state or presentation of information to a user that is indicative of a security domain element that is in the ELEMENT_TERMINATED state or ELEMENT_FROZEN state may be indicative to a user that the security domain element is in such a removed and non-functional state (e.g., by greying out that information and/or making it unselectable). Moreover, if a security domain element in the ELEMENT_TERMINATED state or ELEMENT_FROZEN state offers an internal interface (e.g., through a shareable interface object (“SIO”)), device 100 may be configured to make such an internal interface no longer functional once the security domain element transitions to the ELEMENT_TERMINATED state or ELEMENT_FROZEN state. It is also to be noted that the only supported SD command targeting a security domain element that is in the ELEMENT_TERMINATED state or ELEMENT_FROZEN state may be the DELETE command. For example, an applet in an ELEMENT_FROZEN state may be configured not to participate in an NFC or E-Commerce transaction (e.g., as communication 15 or communication 18) but may still enable service provider subsystem 350 and/or administration entity subsystem 400 from accessing and/or sending APDUs to the applet (e.g., by authenticating to the SSD associated with that applet). In some embodiments, even if service provider subsystem 350 and/or administration entity subsystem 400 may be enabled to send APDUs (e.g., a read stored value APDU) to the applet, because a transition to the ELEMENT_FROZEN state may be irreversible, service provider subsystem 350 and/or administration entity subsystem 400 may not be enabled to re-enable the instance for NFC or E-Commerce use (e.g., as communication 15 or communication 18). A mark-for-delete command may be sent to ISD 152 (e.g., a master security domain), which may be the only domain operative to physically delete an applet (e.g., unless there are other SDs with card content management capabilities, such as Authorized or Delegated Management). All commands may be sent to an applet in an ELEMENT_FROZEN state over a wired interface.

At some point after, if not prior to or during, step 518, process 500 may proceed to step 522 where electronic device 100 may be communicatively coupled to a trusted service manager of the security domain element whose state was transitioned to a removal state (e.g., ELEMENT_TERMINATED or ELEMENT_FROZEN) at step 514 (e.g., the communicative coupling of step 522 may occur after step 518 or the communicative coupling of step 520 may exist during one, some, or all of steps 510-518) and/or to a trusted service manager of secure element 145. For example, if credential applet 153a was transitioned to the ELEMENT_TERMINATED state or ELEMENT_FROZEN state at step 514, step 522 may include electronic device 100 being communicatively coupled to administration entity subsystem 400 (e.g., directly via communications path 55) and/or to service provider subsystem 350 (e.g., directly via communications path 75 or indirectly through administration entity subsystem 400 via communications paths 65 and 55). Such a communicative coupling may occur for any suitable reason (e.g., at the request of service provider subsystem 350, administration entity subsystem 400, and/or device 100). When such a communicative coupling is made, shared TSM data 572 may be communicated from device 100 to the communicatively coupled TSM at step 522 (e.g., to administration entity subsystem 400). Such shared TSM data 572 may include any suitable data that may be appropriate to share with the communicatively coupled TSM (e.g., administration entity subsystem 400). For example, shared TSM data 572 may at least include information that identifies electronic device 100 (e.g., device identification information 119 or a secure element identifier of secure element 145) and information indicative of data in the current CRS list 151 of device 100. Particularly, processor 102 (e.g., SELD application 113a) may be configured to leverage most recently shared CRS list data 568 to generate and transmit shared TSM data 572 that may be indicative of at least the life cycle states of the security domain elements of device 100 that are managed by the communicatively coupled TSM (e.g., administration entity subsystem 400). That is, TSM data 572 may include information indicative of the ELEMENT_TERMINATED state or ELEMENT_FROZEN state of applet credential 153a if such a state was transitioned to at step 514. In response to receiving a “GET STATUS” command (e.g., from SELD application 113a), CRS application 113i may be configured to include the ELEMENT_TERMINATED or ELEMENT_FROZEN status of the security domain elements currently in that life cycle state (e.g., in any shared CRS list data 558/568). Device 100 may be configured to communicate shared TSM data 572 at step 522 automatically in response to being communicatively coupled to a TSM. Alternatively, device 100 may be configured to communicate shared TSM data 572 in response to a request for such data that may be made by the TSM in response to being communicatively coupled to device 100 (e.g., any suitable push or pull technique).

In response to receiving shared TSM data 572 at step 522, the communicatively coupled TSM may process the received TSM data at step 524 of process 500. For example, administration entity subsystem 400 may analyze shared TSM data 572 in any suitable way at step 524 to determine whether any security domain element of device 100 managed by administration entity subsystem 400 has had its life cycle state transitioned to a removal state (e.g., to an ELEMENT_TERMINATED state or to an ELEMENT_FROZEN state). If such a determination is made, administration entity subsystem 400 may reconcile this transition by deleting any suitable security domain element data from secure element 145 or otherwise from device 100 and updating any suitable data maintained by administration entity subsystem 400 that may be associated with the managed credentials on device 100 (e.g., in table 430) and/or providing any appropriate service provider subsystem with data indicative of such removal in order to enable the appropriate service provider subsystem (e.g., the service provider subsystem that provisioned the removed security domain element) to update any suitable data maintained by the service provider subsystem that may be associated with the removed credential (e.g., in table 352). For example, in response to administration entity subsystem 400 determining at step 524 that a particular security domain element of device 100 managed by administration entity subsystem 400 has had its life cycle state transitioned to ELEMENT_TERMINATED or ELEMENT_FROZEN, service provider subsystem 350 may generate and transmit remove element data 582 to device 100 at step 532 that may be configured to delete or otherwise complete the termination and/or removal of that particular security domain element from device 100 (e.g., remove element data 582 may include a “DELETE” SD command that may be supported by GlobalPlatform). As shown in FIG. 2A, such remove element data 582 (e.g., any suitable script or command) may be received by device 100 (e.g., via communications component 106 from communications paths 65 of FIG. 1A) and processor 102 (e.g., SELD application 113a) may pass such remove element data 582 on to ISD 152 (e.g., CRS application 153i). ISD 152 (e.g., CRS application 153i) may process and act on that received remove element data 582 at step 532 to potentially delete or otherwise complete the termination or removal of a particular security domain element currently in the ELEMENT_TERMINATED or ELEMENT_FROZEN state by transmitting suitable remove element data 582 to the particular security domain element. For example, ISD 152 may process remove element data 582 (e.g., to determine if the transmitting TSM (e.g., administration entity subsystem 400 has authority to delete the indicated security domain element) and, if appropriate, then transmit suitable remove element data 582 to that particular security domain element for deleting that security domain element from secure element 145 (e.g., deleting any suitable applet credential information 158 and/or keys and/or an entire applet or SSD as appropriate. Also, at step 534 of process 500, CRS list 151 of CRS application 153i may be updated (e.g., by ISD 152) to reflect the fact that a security domain element has been deleted or otherwise removed from secure element 145 such that CRS list 151 may remove any information regarding that security domain element (e.g., an ELEMENT_TERMINATED or ELEMENT_FROZEN state in CRS list 151 may be completely removed from CRS list 151 as the associated security domain element may no longer exist at all on device 100). Then, at step 536, updated data 586 may be shared from device 100 to administration entity subsystem 400, where at least certain data from CRS list 151 of secure element 145 may be shared with processor 102 of device 100 (e.g., with SELD application 113a) and updated data 586 indicative of data in the current CRS list 151 of device 100 may be communicated between device 100 and administration entity subsystem 400. Particularly, device 100 (e.g., CRS application 153i and SELD application 113a) may be configured to utilize the most recently updated CRS list (e.g., from step 534) to generate and transmit shared updated data 586 that may be indicative of no life cycle state for the now deleted security domain element (e.g., the security domain element removed at step 532).

In response to receiving such updated data 586 at step 536, administration entity subsystem 400 may analyze such updated data 586 in any suitable way at step 538 to determine whether any security domain element has been removed from device 100 (e.g., by comparing updated data 586 with previously received TSM data 572). If such a determination is made, administration entity subsystem 400 may reconcile this transition by updating any suitable data maintained by administration entity subsystem 400 that may be associated with the managed credentials on device 100 (e.g., in table 430) by unlinking any suitable administration linking data at step 538. For example, at step 538, administration entity subsystem 400 may unlink or clear or otherwise remove any data that may have indicated a life cycle of the now deleted security domain element on device 100 (e.g., such that administration entity subsystem 400 may no longer manage or otherwise track that security domain element on device 100 (e.g., in table 430)). Moreover, at step 540, administration entity subsystem 400 may share service provider (“S.P.”) removal data 590 with an appropriate service provider subsystem 350 that may be associated with the now deleted security domain element (e.g., the service provider subsystem that may have provisioned that security domain element on device 100 at step 504), and that service provider subsystem may use such removal data 590 at step 542 to unlink or clear or otherwise remove any data or any service provider link(s) that may be associated with the now deleted security domain element with respect to device 100. For example, if a credential applet defined by a virtual commerce credential (e.g., a D-PAN) has been deleted or otherwise removed from device 100, service provider subsystem 350 may be configured to receive removal data 590 and update virtual-linking table 352 at step 542 to remove the link for that virtual commerce credential (e.g., such that the virtual credential may be linked to another actual credential and provisioned on another electronic device).

Steps 532, 534, 536, 538, 540, and 542 may occur in response to administration entity subsystem 400 detecting at step 524 that any security domain element had been transitioned to a removal state (e.g., to an ELEMENT_TERMINATED state or to an ELEMENT_FROZEN state), such that certain data associated with that security domain element may be deleted or otherwise removed from device 100 (e.g., credential data 158 and/or pass data 138 and and/or life cycle state data) and/or such that certain data associated with that security domain element may be updated or removed at administration entity subsystem 400 (e.g., at table 430) and/or at service provider subsystem 350 (e.g., at table 352) to account for the removal of that security domain element from device 100 (e.g., to prevent any unauthorized use of that security domain element in the future (e.g., any data that may have been previously stolen or sniffed from device 100)). However, when administration entity subsystem 400 may detect at step 524 that a security domain element has been transitioned to an ELEMENT_FROZEN state, one or more additional subprocesses (e.g., steps 526-530) may occur to salvage any stored value of that security domain element before certain data associated with that security domain element may be deleted or otherwise removed from device 100 (e.g., at step 532). For example, when it is detected at step 524 that a security domain element has been transitioned to an ELEMENT_FROZEN state, administration entity subsystem 400 may generate and transmit redirect request data 576 to electronic device 100 at step 526. Redirect request data 576 may include any suitable data operative to instruct and/or enable device 100 to communicate with an appropriate service provider subsystem (e.g., service provider subsystem 350 that may have provisioned the security domain element at step 504 that has since been transitioned to an ELEMENT_FROZEN state) for enabling a stored value and/or any other suitable data associated with the security domain element to be accessed by the service provider subsystem. For example, redirect request data 576 may include a uniform resource locator (“URL”) or any other suitable address information associated with the service provider subsystem that may enable device 100 to properly address a communication from device 100 to that target service provider subsystem (e.g., administration entity subsystem 400 may be operative to identify such address information of service provider subsystem 350 based on data in table 430 associated with the managed credential identified to have been transitioned to an ELEMENT_FROZEN state). Additionally or alternatively, redirect request data 576 may include any suitable information operative to instruct device 100 to communicate with service provider subsystem 350 for enabling the sharing of certain device data. Next, in response to receiving such redirect request data 576, electronic device 100 may be operative to communicate removal session data 578 with service provider subsystem 350 at step 528 (e.g., via any suitable communications path 75 or via administration entity subsystem 400 and paths 55 and 65). Removal session data 578 may include any data that may be communicated from device 100 to service provider subsystem 350 and/or any data that may be communicated from service provider subsystem 350 to device 100 that may enable the stored value of the security domain element that has been transitioned to an ELEMENT_FROZEN state. For example, initial removal session data 578 may be communicated from device 100 to service provider subsystem 350 that may include identification of the security domain element and its current state (e.g., an applet identifier (“AID”) that may be a unique identifier of the security domain element and/or a life cycle state of the security domain identifier (e.g., ELEMENT_FROZEN) a secure element identifier (“SEID”) that may be a unique identifier of the secure element and/or the like). In response, service provider subsystem 350 may generate and communicate responsive removal session data 578 that may include one or more scripts that may request suitable data from the security domain element, such as the current stored value of the security domain element (e.g., a portion of credential information 158 of the security domain element). Such responsive removal session data 578 may be encrypted or signed or otherwise based on a shared secret between service provider subsystem 350 and the security domain element (e.g., a key 155a) that may enable the security domain element to trust the responsive removal session data 578 and respond with the requested data as another instance of removal session data 578 back to service provider subsystem 350, which may also use a shared secret to securely communicate the requested data. Removal session data 578 may share certain data of the security domain element with service provider subsystem 350 but may not enable any data of the security domain element to be modified or removed from device 100. For example, removal session data 578 of step 528 may enable service provider subsystem 350 to read out the current stored value of the security domain element that has been marked-for-freeze but may not enable service provider subsystem 350 to actually remove that security domain element instance from device 100. However, such obtained stored value data may be utilized by service provider subsystem 350 in any suitable manner (e.g., the stored value data of the frozen security domain element may be stored in table 352 in association with any other suitable data for that security domain element, such as owner and/or the like) to enable the stored value to be provisioned on another electronic device or otherwise used by an appropriate owner of that value despite that value no longer being able to be used in a transaction between device 100 and a merchant subsystem. With a stored value credential, for example, that may be marked-for-delete, because the truth of the value may be on the device credential, service provider subsystem 350 and/or administration entity subsystem 400 may be configured with the ability to do an immediate transfer. If this weren't possible, service provider subsystem 350 and/or administration entity subsystem 400 may have to either wait for all offline terminals to sync with service provider subsystem 350 and/or administration entity subsystem 400 or take a risk of provisioning with a stale value. An SIO interface may enable inter-applet-communication while a master applet may be communicating through a wired interface, through which stored value recovery commands may be communicated. Then, once such data (e.g., current stored value data) has been shared by device 100 with service provider subsystem 350 at step 528, device 100 may communicate any suitable redirect response data 580 to administration entity subsystem 400 at step 530 that may indicate to administration entity subsystem 400 that the data has been successfully shared. In response to receiving such redirect response data 580 at step 530, administration entity subsystem 400 may be operative to determine that the security domain element that has been marked-for-freeze may now be removed from device 100 (e.g., without fear of destroying stored value data prior to that value being determined by service provider subsystem 350), such that administration entity subsystem 400 may proceed to step 532, as described above, for removing the frozen security domain element from device 100. Therefore, a security domain element that has been marked-for-freeze may then be removed from device 100 like a security domain element that has been marked-for-delete, but after a stored value has been obtained by an appropriate service provider subsystem. In other embodiments, when a security domain element has been marked-for-freeze, the current stored value of that security domain element may be obtained by device 100 and shared with administration entity subsystem 400 (e.g., as a portion of TSM data 572 at step 522 (e.g., via CRS list data 568)), such that administration entity subsystem 400 may share that stored value directly with service provider subsystem 350 (e.g., as a portion of removal data 590 at step 540).

As mentioned, as an alternative to when a user instruction may be provided on device 100 via UI application 113b to SELD application 113a as a state transition request at step 510, such an initiate element removal instruction may not be generated on device 100 but may instead be generated on another device or subsystem of system 1. For example, at step 511a, a system user may interact with a remote entity or secondary device (e.g., a user's secondary device (e.g., similar to device 100 but distinct from device 100, such as a user's laptop computer as a secondary device to device 100 as a mobile telephone device)) to provide an instruction to initiate removal of one or more credentials on device 100 (e.g., via accessing an online portal to a user's account at administration entity subsystem 400 for managing user devices (e.g., an iCloud account of a user may be securely accessed by a secondary device and an instruction (e.g., a remote wipe instruction) may be received by administration entity subsystem 400 at step 511a that may be eventually used to remove one or more credentials from device 100 when communication is enabled between device 100 and administration entity subsystem 400)). For example, at step 511a, a user may interface with administration entity subsystem 400 to selectively identify at least one security domain element to be removed (e.g., deleted or frozen) from device 100 (e.g., by interfacing with suitable data from table 430 indicative of security domain elements on device 100), or administration entity subsystem 400 may be configured to detect a condition (e.g., fraud alert) in response to which administration entity subsystem 400 may automatically identify at least one security domain element to be removed (e.g., deleted or frozen) from device 100. In response to receiving such an initiate element removal instruction at step 511a, administration entity subsystem 400 may analyze such an initiate element removal instruction and determine whether device 100 is currently communicatively coupled to administration entity subsystem 400 (e.g., also at step 511a). If device 100 is determined to be currently communicatively coupled to administration entity subsystem 400, then process 500 may proceed from step 511a to step 511e, where device removal data 561e may be communicated to device 100 (e.g., to processor 102) that may be similar to initiate element removal data that maybe received by processor 102 at step 510 had the initiate element removal instruction been initiated at device 100 at step 510 rather than at administration entity subsystem 400 at step 511a, where such device removal data 561e may result in appropriate state transition request data 562 being communicated at step 512, as described herein. However, if no communication coupling is detected or created for any suitable amount of time after an initiate element removal instruction is received at step 511a or immediately after an initiate element removal instruction is received at step 511a, process 500 may advance to step 511b where administration entity subsystem 400 may reconcile this instructed transition to a removal state by updating any suitable data maintained by administration entity subsystem 400 that may be associated with the managed credentials on device 100 (e.g., in table 430) by unlinking any suitable administration linking data (e.g., similarly to step 538). For example, at step 511b, administration entity subsystem 400 may unlink or clear or otherwise remove any data that may have indicated a life cycle of the security domain element to be removed from device 100 (e.g., such that administration entity subsystem 400 may no longer manage or otherwise track that security domain element on device 100 (e.g., in table 430)). Moreover, at step 511c, administration entity subsystem 400 may share service provider (“S.P.”) removal data 561c (e.g., similar to data 590 of step 540) with an appropriate service provider subsystem 350 that may be associated with the security domain element to be removed from device 100 (e.g., the service provider subsystem that may have provisioned that security domain element on device 100 at step 504), and that service provider subsystem may use such removal data 561c at step 511d to unlink or clear or otherwise remove any data or any service provider link(s) that may be associated with the security domain element to be removed from device 100. For example, if a credential applet defined by a virtual commerce credential (e.g., a D-PAN) is to be deleted or otherwise removed from device 100, service provider subsystem 350 may be configured to receive removal data 561c and update virtual-linking table 352 at step 511d to remove the link for that virtual commerce credential (e.g., such that the virtual credential may be linked to another actual credential and provisioned on another electronic device). This may prevent service provider subsystem 350 from authorizing the use of that credential by device 100 after step 511d even if that credential is used appropriately on device 100 prior to that credential being removed from device 100 (e.g., at step 532). After step 511d, whenever administration entity subsystem 400 does communicatively couple with device 100, process 500 may proceed to step 511e for communicating share device removal data 561e to device 100 for completing the removal process on device 100 (e.g., stored value data may be obtained by service provider subsystem 350 at step 528 despite at least some unlinking potentially occurring earlier at step 511d).

Therefore, process 500 may enable a security domain element (e.g., a credential applet or an SSD) to be provisioned on device 100 (e.g., at step 504 during a first communication session between device 100 and a TSM), may enable information indicative of that security domain element to be presented to a user of device 100 for aiding in the use or any other suitable management purpose of that security domain element (e.g., at steps 509 and 510), may enable the life cycle state of that security domain element to be transitioned to a removal state (e.g., an ELEMENT_TERMINATED state or an ELEMENT_FROZEN state) (e.g., at step 514) with or without device 100 being communicatively coupled to a TSM of that security domain element (e.g., after the first communication session between device 100 and the TSM has been terminated), may prevent that security domain element from being utilized by and/or presented to a user of device 100 from that point on (e.g., at step 520) (e.g., for communication of NFC credential data 15 or online credential data 18 to merchant subsystem 200), and/or may then enable that security domain element to be fully deleted from device 100 when device 100 is eventually communicatively coupled to the TSM of that security domain element (e.g., at steps 532 and 534 during a second communication session between device 100 and the TSM that is different than the first communication session), and with a stored value or other suitable data being obtained by a TSM prior to such full deletion (e.g., at steps 526-530 for a marked-for-freeze security domain element). This may enable a user of device 100 to believe that a security domain element has been completely removed from device 100 as soon as that security domain element has been transitioned to the ELEMENT_TERMINATED state or to the ELEMENT_FROZEN state at step 514, despite that security domain element not actually being completely removed from device 100 until the later step 532.

However, in other embodiments, rather than updating the life cycle state of a security domain element to ELEMENT_TERMINATED or ELEMENT_FROZEN at step 514 in response to state transition request data 562 requesting the removal of that security domain element, step 514 may alternatively include actually deleting the security domain element (i.e., rather than waiting to do so at a much later point in time at step 532 in response to remove element data 582 received from a communicatively coupled TSM). Then, in such instances, step 516 may include updating CRS list 151 to be indicative of that deletion (e.g., by completely removing any information regarding that deleted security domain element or by generating a message indicative of the deletion). Then, device 100 may still be configured to prevent any indication of that deleted security domain element to a user of device 100 at step 520 and shared TSM data 572 shared with a communicatively coupled TSM at step 522 may at least include information that identifies electronic device 100 (e.g., secure element 145) and information indicative of data in the current CRS list 151 of device 100. Particularly, processor 102 (e.g., SELD application 113a) may be configured to leverage most recently shared CRS list data 568 updated at step 516 to generate and transmit shared TSM data 572 that may either have no information regarding the security domain element deleted at step 514 or that may include a message indicative of the deletion of the security domain element at step 514. Then, in such a situation, administration entity subsystem 400 may analyze such shared TSM data 572 in any suitable way at step 524 to determine whether any security domain element of device 100 managed by administration entity subsystem 400 has been deleted from device 100 (e.g., by detecting such a message and/or by conferring with data entries of table 430 to determine if one or more credentials previously provisioned on device 100 by administration entity subsystem 400 is not identified in shared TSM data 572 (e.g., by determining that no life cycle state for the previously provisioned credential is indicated by shared TSM data 572)). If such a determination is made, administration entity subsystem 400 may reconcile this deletion by updating any suitable data maintained by administration entity subsystem 400 and/or by service provider subsystem 350. For example, if a credential applet defined by a virtual commerce credential (e.g., a D-PAN) has been deleted from device 100 at step 514, service provider subsystem 350 may be configured to update virtual-linking table 352 at step 542 to remove the link for that virtual commerce credential (e.g., such that the virtual credential may be linked to another actual credential and provisioned on another electronic device). When such a determination is made at step 524 that one or more credentials previously provisioned on device 100 by administration entity subsystem 400 has been deleted from device 100 at step 514, there may be no need for administration entity subsystem 400 to generate and transmit data 576 and/or data 582 to device 100 as described above with respect to step 526 and/or step 532. If the credential applet that has been deleted was a stored value applet, administration entity subsystem 400 and/or service provider subsystem 350 may be configured to determine how much stored value there was on device 100 and enable such value to be re-provisioned onto another device by the user that may own that value (e.g., by identifying a user (e.g., in table 430 or table 352 at step 524) associated with that deleted credential as well as the last known stored value of that credential (e.g., if administration entity subsystem 400 and/or service provider subsystem 350 may be configured to track such information during earlier use of the credential) and then enabling such a value to be re-provisioned on an applet on another device controlled by that user).

It is understood that the steps shown in process 500 of FIG. 5 are only illustrative and that existing steps may be modified or omitted, additional steps may be added, and the order of certain steps may be altered.

FIG. 6 is a flowchart of an illustrative process 600. At step 602 of process 600, the functionality of a security domain element on an electronic device may be terminated (e.g., permanently), for example, while the electronic device is not communicatively coupled to a trusted service manager of the security domain element. For example, as described above with respect to FIGS. 1-5, device 100 may be configured to transition the state of a security domain element to the ELEMENT_TERMINATED removal state or to the ELEMENT_FROZEN removal state (e.g., at steps 514 and 516) with or without device 100 being communicatively coupled to any remote entity, such as service provider subsystem 350 or administration entity subsystem 400, where such a transition may terminate the functionality of that security domain element on device 100 (e.g., terminate the ability of that security domain element to fund a transaction between device 100 and merchant subsystem 200). At step 604 of process 600, the electronic device may be communicatively coupled to a trusted service manager of the security domain element (e.g., device 100 may be communicatively coupled to administration entity subsystem 400 and/or service provider subsystem 350 during any suitable step or steps of process 500 (e.g., device 100 may be coupled to the internet or any other suitable network or cloud or communications path for communicating data with a trusted service manager during some or all steps of process 500)). At step 606 of process 600, after the functionality has been terminated at step 602 and once the device is communicatively coupled at step 604, the electronic device may communicate data to the communicatively coupled trusted service manager, where the communicated data may be usable by the trusted service manager to determine a stored value of the security domain element and/or to determine that the functionality of the security domain element has been terminated on the electronic device. For example, as described above with respect to FIGS. 1-5, once the functionality of a security domain element has been transitioned to the ELEMENT_FROZEN state, removal session data 578 may be communicated from device 100 to service provider subsystem 350 (e.g., at step 528 of process 500) to share a stored value of the security domain element (e.g., where the security domain element may be a commerce credential applet and where the stored value may be indicative of a value of financial funds stored on the commerce credential applet).

It is understood that the steps shown in process 600 of FIG. 6 are only illustrative and that existing steps may be modified or omitted, additional steps may be added, and the order of certain steps may be altered.

As mentioned, and as shown in FIG. 2, electronic device 100 can include, but is not limited to, a music player (e.g., an iPod™ available by Apple Inc. of Cupertino, Calif.), video player, still image player, game player, other media player, music recorder, movie or video camera or recorder, still camera, other media recorder, radio, medical equipment, domestic appliance, transportation vehicle instrument, musical instrument, calculator, cellular telephone (e.g., an iPhone™ available by Apple Inc.), other wireless communication device, personal digital assistant, remote control, pager, computer (e.g., a desktop, laptop, tablet (e.g., an iPad™ available by Apple Inc.), server, etc.), monitor, television, stereo equipment, set up box, set-top box, modem, router, printer, or any combination thereof. In some embodiments, electronic device 100 may perform a single function (e.g., a device dedicated to conducting financial transactions) and, in other embodiments, electronic device 100 may perform multiple functions (e.g., a device that conducts financial transactions, plays music, and receives and transmits telephone calls). Electronic device 100 may be any portable, mobile, hand-held, or miniature electronic device that may be configured to conduct financial transactions wherever a user travels. Some miniature electronic devices may have a form factor that is smaller than that of hand-held electronic devices, such as an iPod™ available by Apple Inc. and/or the like. Illustrative miniature electronic devices can be integrated into various objects that may include, but are not limited to, watches (e.g., an Apple Watch™ available by Apple Inc.), rings, necklaces, belts, accessories for belts, headsets, accessories for shoes, virtual reality devices, glasses, other wearable electronics, accessories for sporting equipment, accessories for fitness equipment, key chains, or any combination thereof. Alternatively, electronic device 100 may not be portable at all, but may instead be generally stationary.

As shown in FIG. 2, for example, electronic device 100 may include a processor 102, memory 104, communications component 106, power supply 108, input component 110, output component 112, antenna 116, and near field communication (“NFC”) component 120. Electronic device 100 may also include a bus 118 that may provide one or more wired or wireless communication links or paths for transferring data and/or power to, from, or between various other components of device 100. In some embodiments, one or more components of electronic device 100 may be combined or omitted. Moreover, electronic device 100 may include other components not combined or included in FIG. 2. For example, electronic device 100 may include any other suitable components or several instances of the components shown in FIG. 2. For the sake of simplicity, only one of each of the components is shown in FIG. 2.

Memory 104 may include one or more storage mediums, including for example, a hard-drive, flash memory, permanent memory such as read-only memory (“ROM”), semi-permanent memory such as random access memory (“RAM”), any other suitable type of storage component, or any combination thereof. Memory 104 may include cache memory, which may be one or more different types of memory used for temporarily storing data for electronic device applications. Memory 104 may be fixedly embedded within electronic device 100 or may be incorporated on one or more suitable types of cards that may be repeatedly inserted into and removed from electronic device 100 (e.g., a subscriber identity module (“SIM”) card or secure digital (“SD”) memory card). Memory 104 may store media data (e.g., music and image files), software (e.g., for implementing functions on device 100), firmware, preference information (e.g., media playback preferences), lifestyle information (e.g., food preferences), exercise information (e.g., information obtained by exercise monitoring equipment), transaction information (e.g., information such as credit card information), wireless connection information (e.g., information that may enable device 100 to establish a wireless connection), subscription information (e.g., information that keeps track of podcasts or television shows or other media a user subscribes to), contact information (e.g., telephone numbers and e-mail addresses), calendar information, any other suitable data, or any combination thereof, such as, for example, application 103 and/or application 113.

Communications component 106 may be provided to allow device 100 to communicate with one or more other electronic devices or servers or subsystems (e.g., one or more subsystems or other components of system 1) using any suitable communications protocol. For example, communications component 106 may support Wi-Fi (e.g., an 802.11 protocol), ZigBee (e.g., an 802.15.4 protocol), WiFi™, Ethernet, Bluetooth™, Bluetooth™ Low Energy (“BLE”), high frequency systems (e.g., 900 MHz, 2.4 GHz, and 5.6 GHz communication systems), infrared, transmission control protocol/internet protocol (“TCP/IP”) (e.g., any of the protocols used in each of the TCP/IP layers), Stream Control Transmission Protocol (“SCTP”), Dynamic Host Configuration Protocol (“DHCP”), hypertext transfer protocol (“HTTP”), BitTorrent™, file transfer protocol (“FTP”), real-time transport protocol (“RTP”), real-time streaming protocol (“RTSP”), real-time control protocol (“RTCP”), Remote Audio Output Protocol (“RAOP”), Real Data Transport Protocol™ (“RDTP”), User Datagram Protocol (“UDP”), secure shell protocol (“SSH”), wireless distribution system (“WDS”) bridging, any communications protocol that may be used by wireless and cellular telephones and personal e-mail devices (e.g., Global System for Mobile Communications (“GSM”), GSM plus Enhanced Data rates for GSM Evolution (“EDGE”), Code Division Multiple Access (“CDMA”), Orthogonal Frequency-Division Multiple Access (“OFDMA”), high speed packet access (“HSPA”), multi-band, etc.), any communications protocol that may be used by a low power Wireless Personal Area Network (“6LoWPAN”) module, any other communications protocol, or any combination thereof. Communications component 106 may also include or be electrically coupled to any suitable transceiver circuitry (e.g., transceiver circuitry or antenna 116 via bus 118) that can enable device 100 to be communicatively coupled to another device (e.g., a host computer or an accessory device) and communicate with that other device wirelessly, or via a wired connection (e.g., using a connector port). Communications component 106 may be configured to determine a geographical position of electronic device 100. For example, communications component 106 may utilize the global positioning system (“GPS”) or a regional or site-wide positioning system that may use cell tower positioning technology or Wi-Fi technology.

One or more input components 110 may be provided to permit a user to interact or interface with device 100. For example, input component 110 can take a variety of forms, including, but not limited to, a touch pad, dial, click wheel, scroll wheel, touch screen, one or more buttons (e.g., a keyboard), mouse, joy stick, track ball, microphone, camera, scanner (e.g., a bar code scanner or any other suitable scanner that may obtain product identifying information from a code, such as a bar code, a QR code, or the like), proximity sensor, light detector, motion sensor, biometric sensor (e.g., a fingerprint reader or other feature recognition sensor, which may operate in conjunction with a feature-processing application that may be accessible to electronic device 100 for authenticating a user), and combinations thereof. Each input component 110 can be configured to provide one or more dedicated control functions for making selections or issuing commands associated with operating device 100.

Electronic device 100 may also include one or more output components 112 that may present information (e.g., graphical, audible, and/or tactile information) to a user of device 100. For example, output component 112 of electronic device 100 may take various forms, including, but not limited to, audio speakers, headphones, audio line-outs, visual displays, antennas, infrared ports, haptic output components (e.g., rumblers, vibrators, etc.), or combinations thereof.

Electronic device 100 may also include near field communication (“NFC”) component 120. NFC component 120 may be any suitable proximity-based communication mechanism that may enable contactless proximity-based transactions or communications 15 between electronic device 100 and merchant subsystem 200 (e.g., a merchant payment terminal). NFC component 120 may allow for close range communication at relatively low data rates (e.g., 424 kbps), and may comply with any suitable standards, such as ISO/IEC 7816, ISO/IEC 18092, ECMA-340, ISO/IEC 21481, ECMA-352, ISO 14443, and/or ISO 15693. Alternatively or additionally, NFC component 120 may allow for close range communication at relatively high data rates (e.g., 370 Mbps), and may comply with any suitable standards, such as the TransferJet™ protocol. Communication between NFC component 120 and merchant subsystem 200 may occur within any suitable close range distance between device 100 and merchant subsystem 200 (see, e.g., distance D of FIG. 1), such as a range of approximately 2 to 4 centimeters, and may operate at any suitable frequency (e.g., 13.56 MHz). For example, such close range communication of NFC component 120 may take place via magnetic field induction, which may allow NFC component 120 to communicate with other NFC devices and/or to retrieve information from tags having radio frequency identification (“RFID”) circuitry. NFC component 120 may provide a manner of acquiring merchandise information, transferring payment information, and otherwise communicating with an external device (e.g., terminal 220 of merchant subsystem 200).

NFC device module 130 may include an NFC data module 132, an NFC antenna 134, and an NFC booster 136. NFC data module 132 may be configured to contain, route, or otherwise provide any suitable data that may be transmitted by NFC component 120 to merchant subsystem 200 as part of a contactless proximity-based or NFC communication 15. Additionally or alternatively, NFC data module 132 may be configured to contain, route, or otherwise receive any suitable data that may be received by NFC component 120 from merchant subsystem 200 as part of a contactless proximity-based communication 15.

NFC transceiver or NFC antenna 134 may be any suitable antenna or other suitable transceiver circuitry that may generally enable communication of communication 15 from NFC data module 132 to merchant subsystem 200 and/or to NFC data module 132 from subsystem 200. Therefore, NFC antenna 134 (e.g., a loop antenna) may be provided specifically for enabling the contactless proximity-based communication capabilities of NFC component 120.

Alternatively or additionally, NFC component 120 may utilize the same transceiver circuitry or antenna (e.g., antenna 116) that another communication component of electronic device 100 (e.g., communication component 106) may utilize. For example, communication component 106 may leverage antenna 116 to enable Wi-Fi, Bluetooth™, cellular, or GPS communication between electronic device 100 and another remote entity, while NFC component 120 may leverage antenna 116 to enable contactless proximity-based or NFC communication 15 between NFC data module 132 of NFC device module 130 and another entity (e.g., merchant subsystem 200). In such embodiments, NFC device module 130 may include NFC booster 136, which may be configured to provide appropriate signal amplification for data of NFC component 120 (e.g., data within NFC data module 132) so that such data may be appropriately transmitted by shared antenna 116 as communication 15 to subsystem 200. For example, shared antenna 116 may require amplification from booster 136 before antenna 116 (e.g., a non-loop antenna) may be properly enabled for communicating contactless proximity-based or NFC communication 15 between electronic device 100 and merchant subsystem 200 (e.g., more power may be needed to transmit NFC data using antenna 116 than may be needed to transmit other types of data using antenna 116).

NFC controller module 140 may include at least one NFC processor module 142. NFC processor module 142 may operate in conjunction with NFC device module 130 to enable, activate, allow, and/or otherwise control NFC component 120 for communicating NFC communication 15 between electronic device 100 and merchant subsystem 200. NFC processor module 142 may exist as a separate component, may be integrated into another chipset, or may be integrated with processor 102, for example, as part of a system on a chip (“SoC”). As shown in FIG. 2, NFC processor module 142 of NFC controller module 140 may be used to run one or more applications, such as an NFC low power mode or wallet application 143 that may help dictate the function of NFC component 120. Application 143 may include, but is not limited to, one or more operating system applications, firmware applications, NFC low power applications, or any other suitable applications that may be accessible to NFC component 120 (e.g., application 103/113). NFC controller module 140 may include one or more protocols, such as the Near Field Communication Interface and Protocols (“NFCIP-1”), for communicating with another NFC device (e.g., merchant subsystem 200). The protocols may be used to adapt the communication speed and to designate one of the connected devices as the initiator device that controls the near field communication.

NFC controller module 140 may control the near field communication mode of NFC component 120. For example, NFC processor module 142 may be configured to switch NFC device module 130 between a reader/writer mode for reading information (e.g., communication 15) from NFC tags (e.g., from merchant subsystem 200) to NFC data module 132, a peer-to-peer mode for exchanging data (e.g., communication 15) with another NFC enabled device (e.g., merchant subsystem 200), and a card emulation mode for allowing another NFC enabled device (e.g., merchant subsystem 200) to read information (e.g., communication 15) from NFC data module 132. NFC controller module 140 also may be configured to switch NFC component 120 between active and passive modes. For example, NFC processor module 142 may be configured to switch NFC device module 130 (e.g., in conjunction with NFC antenna 134 or shared antenna 116) between an active mode where NFC device module 130 may generate its own RF field and a passive mode where NFC device module 130 may use load modulation to transfer data to another device generating an RF field (e.g., merchant subsystem 200). Operation in such a passive mode may prolong the battery life of electronic device 100 compared to operation in such an active mode. The modes of NFC device module 130 may be controlled based on preferences of a user and/or based on preferences of a manufacturer of device 100, which may be defined or otherwise dictated by an application running on device 100 (e.g., application 103 and/or application 143).

NFC memory module 150 may operate in conjunction with NFC device module 130 and/or NFC controller module 140 to allow for NFC communication 15 between electronic device 100 and merchant subsystem 200. NFC memory module 150 may be embedded within NFC device hardware or within an NFC integrated circuit (“IC”). NFC memory module 150 may be tamper resistant and may provide at least a portion of secure element 145. For example, NFC memory module 150 may store one or more applications relating to NFC communications (e.g., application 143) that may be accessed by NFC controller module 140. For example, such applications may include financial payment applications, secure access system applications, loyalty card applications, and other applications, which may be encrypted. In some embodiments, NFC controller module 140 and NFC memory module 150 may independently or in combination provide a dedicated microprocessor system that may contain an operating system, memory, application environment, and security protocols intended to be used to store and execute sensitive applications on electronic device 100. NFC controller module 140 and NFC memory module 150 may independently or in combination provide at least a portion of secure element 145, which may be tamper resistant. For example, such a secure element may be configured to provide a tamper-resistant platform (e.g., as a single or multiple chip secure microcontroller) that may be capable of securely hosting applications and their confidential and cryptographic data (e.g., applet 153 and key 155) in accordance with rules and security requirements that may be set forth by a set of well-identified trusted authorities (e.g., an authority of service provider subsystem and/or an industry standard, such as GlobalPlatform). NFC memory module 150 may be a portion of memory 104 or at least one dedicated chip specific to NFC component 120. NFC memory module 150 may reside on a SIM, a dedicated chip on a motherboard of electronic device 100, or as an external plug in memory card. NFC memory module 150 may be completely independent from NFC controller module 140 and may be provided by different components of device 100 and/or provided to electronic device 100 by different removable subsystems.

As shown in FIGS. 2 and 4, NFC memory module 150 may include one or more of an issuer security domain (“ISD”) 152 and a supplemental security domain (“SSD”) 154 (e.g., a service provider security domain (“SPSD”), a trusted service manager security domain (“TSMSD”), etc.), which may be defined and managed by an NFC specification standard (e.g., GlobalPlatform). For example, ISD 152 may be a portion of NFC memory module 150 in which a trusted service manager (“TSM”) or issuing institution (e.g., administration entity subsystem 400 and/or service provider subsystem 350) may store keys and/or other suitable information for creating or otherwise provisioning one or more credentials (e.g., commerce credentials associated with various credit cards, bank cards, gift cards, access cards, transit passes, digital currency (e.g., bitcoin and associated payment networks), etc.) on electronic device 100 (e.g., via communications component 106), for credential content management, and/or for security domain management. A specific supplemental security domain (“SSD”) 154 (e.g., one of SSDs 154a and 154b) may be associated with a particular TSM and at least one specific commerce credential (e.g., a specific credit card credential or a specific public transit card credential) that may provide specific privileges or payment rights to electronic device 100. Each SSD 154 may have its own manager key 155 (e.g., a respective one of keys 155a and 155b) and at least one of its own credential applications or credential applets (e.g., a Java card applet instances) associated with a particular commerce credential (e.g., credential applets 153a and 153a′ of SSD 154a and credential applets 153b and 153b′ of SSD 154b), where a credential applet may have its own applet key (e.g., applet key 155aa for credential applet 153a, applet key 155aa′ for credential applet 153a′, applet key 155ba for credential applet 153b, and applet key 155ba′ for credential applet 153b′) and where a credential applet may need to be activated to enable its associated commerce credential for use by NFC device module 130 as an NFC communication 15 between electronic device 100 and merchant subsystem 200. For example, a first payment network subsystem 360 (e.g., Visa) may be the TSM for first SSD 154a and the different applets 153a and 153a′ of first SSD 154a may be associated with different commerce credentials managed by that first payment network subsystem 360, while a second payment network subsystem 360 (e.g., MasterCard) may be the TSM for second SSD 154b and the different applets 153b and 153b′ of second SSD 154b may be associated with different commerce credentials managed by that second payment network subsystem 360, where one credential applet of an SSD can be deleted while another credential applet of that same SSD may be maintained. Alternatively, each credential applet 153 may be provided by its own SSD 154.

Security features may be provided for enabling use of NFC component 120 (e.g., for enabling activation of commerce credentials provisioned on device 100) that may be particularly useful when transmitting confidential payment information, such as credit card information or bank account information of a credential, from electronic device 100 to merchant subsystem 200 as NFC communication 15. Such security features also may include a secure storage area that may have restricted access. For example, user authentication via personal identification number (“PIN”) entry or via user interaction with a biometric sensor (e.g., fingerprint possession) may need to be provided to access the secure storage area (e.g., for a user to alter a life cycle state of a security domain element of secure element 145). In certain embodiments, some or all of the security features may be stored within NFC memory module 150. Further, security information, such as an authentication key, for communicating with subsystem 200 may be stored within NFC memory module 150. In certain embodiments, NFC memory module 150 may include a microcontroller embedded within electronic device 100.

While NFC component 120 has been described with respect to near field communication, it is to be understood that component 120 may be configured to provide any suitable contactless proximity-based mobile payment or any other suitable type of contactless proximity-based communication 15 between electronic device 100 and merchant subsystem 200. For example, NFC component 120 may be configured to provide any suitable short-range communication, such as those involving electromagnetic/electrostatic coupling technologies.

Electronic device 100 may also include at least one haptic or tactile output component 112c (e.g., a rumbler), a camera and/or scanner input component 110h (e.g., a video or still camera, and/or a bar code scanner or any other suitable scanner that may obtain product identifying information from a code, such as a bar code, a QR code, or the like), and a biometric input component 110i (e.g., a fingerprint reader or other feature recognition sensor, which may operate in conjunction with a feature-processing application that may be accessible to electronic device 100 for authenticating a user). As shown in FIG. 3, at least a portion of biometric input component 110i may be incorporated into or otherwise combined with input component 110a or any other suitable input component 110 of device 100. For example, biometric input component 110i may be a fingerprint reader that may be configured to scan the fingerprint of a user's finger as the user interacts with mechanical input component 110a by pressing input component 110a with that finger. As another example, biometric input component 110i may be a fingerprint reader that may be combined with touch input component 110f of touch screen I/O component 114a, such that biometric input component 110i may be configured to scan the fingerprint of a user's finger as the user interacts with touch screen input component 110f by pressing or sliding along touch screen input component 110f with that finger. Moreover, as mentioned, electronic device 100 may further include NFC component 120, which may be communicatively accessible to subsystem 200 via antenna 116 and/or antenna 134 (not shown in FIG. 3). NFC component 120 may be located at least partially within housing 101, and a mark or symbol 121 can be provided on the exterior of housing 101 that may identify the general location of one or more of the antennas associated with NFC component 120 (e.g., the general location of antenna 116 and/or antenna 134).

Moreover, one, some, or all of the processes described with respect to FIGS. 1-6 may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 104 and/or memory module 150 of FIG. 2). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device to another electronic device using any suitable communications protocol (e.g., the computer-readable medium may be communicated to electronic device 100 via communications component 106 (e.g., as at least a portion of an application 103 and/or as at least a portion of an application 113 and/or as at least a portion of an application 143)). Such a computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any, each, or at least one module or component or subsystem of system 1 may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

At least a portion of one or more of the modules or components or subsystems of system 1 may be stored in or otherwise accessible to an entity of system 1 in any suitable manner (e.g., in memory 104 of device 100 (e.g., as at least a portion of an application 103 and/or as at least a portion of an application 113 and/or as at least a portion of an application 143)). For example, any or each module of NFC component 120 may be implemented using any suitable technologies (e.g., as one or more integrated circuit devices), and different modules may or may not be identical in structure, capabilities, and operation. Any or all of the modules or other components of system 1 may be mounted on an expansion card, mounted directly on a system motherboard, or integrated into a system chipset component (e.g., into a “north bridge” chip).

Any or each module or component of system 1 (e.g., any or each module of NFC component 120) may be a dedicated system implemented using one or more expansion cards adapted for various bus standards. For example, all of the modules may be mounted on different interconnected expansion cards or all of the modules may be mounted on one expansion card. With respect to NFC component 120, by way of example only, the modules of NFC component 120 may interface with a motherboard or processor 102 of device 100 through an expansion slot (e.g., a peripheral component interconnect (“PCI”) slot or a PCI express slot). Alternatively, NFC component 120 need not be removable but may include one or more dedicated modules that may include memory (e.g., RAM) dedicated to the utilization of the module. In other embodiments, NFC component 120 may be integrated into device 100. For example, a module of NFC component 120 may utilize a portion of device memory 104 of device 100. Any or each module or component of system 1 (e.g., any or each module of NFC component 120) may include its own processing circuitry and/or memory. Alternatively, any or each module or component of system 1 (e.g., any or each module of NFC component 120) may share processing circuitry and/or memory with any other module of NFC component 120 and/or processor 102 and/or memory 104 of device 100.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

While there have been described systems, methods, and computer-readable media for managing credentials on an electronic device, it is to be understood that many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method comprising:
terminating the functionality of a security domain element on an electronic device;
communicatively coupling the electronic device to a trusted service manager of the security domain element; and
after the terminating, communicating data from the electronic device to the communicatively coupled trusted service manager, wherein the communicated data is usable by the trusted service manager to determine a stored value of the security domain element.

2. The method of claim 1, wherein the terminating occurs while the electronic device is not communicatively coupled to the trusted service manager.

3. The method of claim 1, wherein the terminating occurs while the electronic device is communicatively coupled to the trusted service manager.

4. The method of claim 1, wherein the security domain element comprises a commerce credential applet.

5. The method of claim 1, further comprising:
before the terminating, communicatively coupling the electronic device to the trusted service manager;
before the terminating, receiving the security domain element on the electronic device from the communicatively coupled trusted service manager; and
before the terminating but after the receiving, communicatively de-coupling the electronic device from the trusted service manager.

6. The method of claim 5, wherein the receiving further comprises receiving a functionality data register for the security domain element configured to allow the transition of a life cycle state of the security domain element from a first type of life cycle state to a second type of life cycle state.

7. The method of claim 1, wherein the communicated data is indicative of a life cycle state of the security domain element.

8. The method of claim 7, further comprising:
after the communicating, receiving shared data at the electronic device from the communicatively coupled trusted service manager; and
using the received shared data to delete the security domain element from the electronic device.

9. The method of claim 1, wherein the communicated data is not indicative of a life cycle state of the security domain element.

10. The method of claim 1, wherein the terminating comprises freezing the security domain element from the electronic device.

11. The method of claim 1, wherein the terminating comprises transitioning a life cycle state of the security domain element from a first type of life cycle state to a second type of life cycle state.

12. The method of claim 11, wherein:
the terminating further comprises detecting a value of a functionality data register of the security domain element; and
the detected value of the functionality data register is configured to allow the transitioning.

13. The method of claim 1, wherein the communicated data is usable by the trusted service manager to determine that the functionality of the security domain element has been terminated on the electronic device.

14. The method of claim 1, wherein:
the security domain element comprises a commerce credential applet; and
the stored value is indicative of a value of financial funds stored on the commerce credential applet.
